(19) United States
(12) Patent Application Publication
(10) Pub. No.: US 2025/0305085 A1
(43) Pub. Date: Oct. 2, 2025

(54) METHODS TO RECOVER CRITICAL MINERALS FROM AQUEOUS SOLUTIONS

(71) Applicant: West Virginia University Board of Governors on Behalf of West Virginia University, Morgantown, WV (US)

(72) Inventors: Oishi Sanyal, Morgantown, WV (US); Shawn Grushecky, Morgantown, WV (US); Hassan Amini, Chino Hills, CA (US); Deniz Talan, Morgantown, WV (US)

(21) Appl. No.: 19/093,772

(22) Filed: Mar. 28, 2025

Related U.S. Application Data
(60) Provisional application No. 63/570,959, filed on Mar. 28, 2024.

(51) Int. Cl. C22B 3/24; B01J 20/20; B01J 20/28; B01J 20/30; C02F 1/28; C02F 1/66; C02F 101/20; C02F 103/10

(52) U.S. Cl. CPC C22B 3/24; B01J 20/20; B01J 20/28011; B01J 20/28059; B01J 20/28061; B01J 20/28064; B01J 20/3021; B01J 20/3078; C02F 1/288; C02F 1/66; C02F 1/283; C02F 2101/20; C02F 2103/10

(57) ABSTRACT

In one aspect, the disclosure relates to a method for recovering critical minerals from a solution, the method comprising: (a) providing a critical mineral solution comprising at least one critical mineral and water; (b) contacting the critical mineral solution with an acid or a base in an amount sufficient enough to adjust the pH to a value of about 2 to about 7; (c) contacting the critical mineral solution with a first modified biochar, forming a first saturated biochar; and (d) desorbing the first saturated biochar, thereby forming a first critical mineral precipitate, a first stripped biochar, and a first aqueous phase. This abstract is intended as a scanning tool for purposes of searching in the particular art and is not intended to be limiting of the present disclosure.

### CROSS-REFERENCE TO RELATED APPLICATIONS

This application claims the benefit of and priority to U.S. Provisional Application No. 63/570,959, filed on Mar. 28, 2024, which is incorporated herein by reference in its entirety.

### BACKGROUND

Acid Mine Drainage (AMD), an extremely acidic and metal-rich solution, is a global challenge encountered by mining industries, including coal mining. The release of untreated AMD poses a risk of contaminating nearby water sources and sediments with detrimental effects on biodiversity. The environmental and economic impacts of AMD have driven the strategic development of sustainable prevention and remediation solutions. While prevention strategies are ideal, the practical implementation of atsource treatment is a challenging task. Instead, various active and passive remediation methods are currently considered the most beneficial alternatives for treating AMD. Of all techniques, conventional pH control with cost-effective neutralization reagents is the most widely used and least expensive approach for AMD remediation. Nevertheless, it results in producing a high volume of sludge (AMD treatment product or AMD precipitate) that requires further management and appropriate disposal. Despite being considered an environmental problem, AMD and its treatment product contain high concentrations of valuable critical minerals (CMs), including aluminum, cobalt, manganese, and rare earth elements (REEs).

REEs and other CMs are significantly important to the global economy due to their applications in renewable energy, defense, and medical industries. These minerals can be extracted from AMD, but many of the common extraction techniques are high cost and can have negative environmental impacts. Thus, there is a need for cost-effective and environmentally sustainable techniques for processing AMD and AMD precipitate and recovering CMs from the same. These needs and other needs are satisfied by the present disclosure.

### SUMMARY

In accordance with the purpose of the disclosure, as embodied and broadly described herein, the disclosure, in one aspect, relates to a method for recovering critical minerals from a solution, the method comprising: (a) providing a critical mineral solution comprising at least one critical mineral and water; (b) contacting the critical mineral solution with an acid or a base in an amount sufficient enough to adjust the pH to a value of about 2 to about 7; (c) contacting the critical mineral solution with a first modified biochar, forming a first saturated biochar; and (d) desorbing the first saturated biochar, thereby forming a first critical mineral precipitate, a first stripped biochar, and a first aqueous phase.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 provides a representative flow diagram of a method of recovering critical minerals according to various embodiments of the present disclosure.

FIG. 2 shows representative Zeta potential measurements for biochars: softwood (SW), wood chip and chicken litter (WCC), and Appalachian hardwood (AH).

FIGS. 3A-3C show representative relative applied pressure against quantity absorbed for SW biochar (FIG. 3A), WCC biochar (FIG. 3B), and AH biochar (FIG. 3C).

FIG. 4 shows representative pore size distributions of SW, WCC, and AH.

FIGS. 5A-5C shows representative scanning electron microscope (SEM) images of biochars for SW (FIG. 5A), WCC (FIG. 5B), and AH (FIG. 5C) before lanthanum adsorption.

FIG. 6 shows representative effects of pH on the adsorption of lanthanum.

FIG. 7 shows representative effects of contact time on the adsorption of lanthanum at pH 5.

FIG. 8 shows representative effects of initial element concentration on the adsorption capacity at pH 5.

FIG. 9 shows representative effects of initial element concentration on the adsorption performance at pH 5.

FIG. 10 shows representative desorption of lanthanum-loaded AH biochar using different reagents at varying concentrations.

FIG. 11 shows representative Fourier transform infrared spectroscopy patterns of biochars before and after the adsorption of lanthanum.

FIGS. 12A-12C show a representative SEM/energy dispersive spectroscopy (EDS) image (FIG. 12A), a representative point analysis (FIG. 12B), and a representative EDS mapping (FIG. 12C) of SW biochar after lanthanum adsorption.

FIGS. 12D-12F show a representative SEM/EDS image (FIG. 12D), a representative point analysis (FIG. 12E), and a representative EDS mapping (FIG. 12F) of WCC biochar after lanthanum adsorption.

FIGS. 12G-12I show a representative SEM/EDS image (FIG. 12G), a representative point analysis (FIG. 12H), and a representative EDS mapping (FIG. 12I) of WCC biochar after lanthanum adsorption.

FIG. 13 shows representative adsorption of rare earth elements (REEs) on AH biochar in the presence of other critical and/or impurity elements, where the bars for each t value represent, from left to right: yttrium, lanthanum, cerium, neodymium, aluminum, calcium, and iron.

FIG. 14 illustrates representative mechanisms for cation adsorption on biochar surface (Tan et al., 2020).

FIG. 15A shows representative sulfate removal using aluminum chloride at 1800 ppm initial sulfate concentration.

FIG. 15B shows representative iron precipitation after oxidation using NaOH.

FIG. 16 shows a representative effect of HCl wash on Al uptake using SW biochar.

FIG. 17 shows representative adsorption recovery of elements using an acid mine drainage (AMD) feedstock under baseline test conditions.

FIG. 18 illustrates a representation of biochar functionalization (Tomczyk et al., 2023).

FIG. 19 shows SEM images of 500 μm raw (untreated) biochar.

FIG. 20 shows SEM images of 75 μm biochar after a 1M nitric acid wash.

FIG. 21 shows SEM images of 500 μm biochar after a 1M nitric acid wash.

FIG. 22 shows SEM images of 75 μm biochar after a 3M nitric acid wash.

FIG. 23 shows SEM images of 500 μm biochar after a 3M nitric acid wash.

FIG. 24 shows SEM images of 75 μm biochar after a 1M hydrochloric acid wash.

FIG. 25 shows SEM images of 75 μm biochar after a 3M hydrochloric acid wash.

FIG. 26 shows SEM images of 500 μm biochar after a 1M hydrochloric acid wash.

FIG. 27 shows SEM images of 500 μm biochar after a 3M hydrochloric acid wash.

FIG. 28 shows representative effects of air drying (A) and oven drying (O) on biochar functional groups after a water wash for 12 hours.

FIG. 29 shows representative effect of air drying (A) and oven drying (O) on biochar functional groups after a hydrochloric acid (HCL) wash for 12 hours.

FIG. 30 shows representative effects of air drying (A) and oven drying (O) on biochar functional groups after a nitric acid (HNO3) wash for 12 hours.

FIG. 31 shows representative adsorption test results completed with acid and base modified biochars.

FIG. 32 shows representative effects of biochar particle size on rare earth element adsorption recovery, where the bars for each rare earth element represent, from left to right: particle sizes of 500 μm, 75 μm, and 125-212 μm.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures of two or more such rare earth elements, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a buffer refers to an amount that is sufficient to achieve the desired improvement in the property modulated by the formulation component, e.g., achieving and maintaining a desired solution pH. The specific level in terms of wt % in a composition required as an effective amount will depend upon a variety of factors including the amount and type of buffer, size of processing plant (i.e., bench top, mobile, or commercial scale), amount and type of feedstock being treated, and end use of the REEs recovered during the process.

As used herein, the terms “optional” or “optionally” means that the subsequently described event or circumstance can or cannot occur, and that the description includes instances where said event or circumstance occurs and instances where it does not.

As used herein, the term “rare earth element” (REE), in the context of the present disclosure, refers to a composition comprising one or more rare earth elements, including one or more of a lanthanide chemical element, i.e., cerium, dysprosium, erbium, europium, gadolinium, holmium, lanthanum, lutetium, neodymium, praseodymium, samarium, scandium, terbium, thulium, ytterbium, and yttrium. The elements scandium and yttrium often occur in the same ore deposits as lanthanides and also have some similar chemical properties. Rare earth elements are useful in a variety of applications in the electronics, defense, and medical industries, as well as in other applications. An oxide of a rare earth element is a “rare earth oxide” and can be used for analytical purposes or may be useful as a component of ceramics, catalysts, and/or coatings, among other uses. It is to be understood that when referencing rare earth elements that any of the elements can be present in a zero valence or elemental state, or in an ionized or valence state associated in the art with the individual element, and all forms are understood to be collectively included within the meaning of “rare earth elements”. Moreover, it is to be understood that reference to any individual rare earth element, i.e., any one of lanthanum, cerium, praseodymium, neodymium, samarium, europium, gadolinium, terbium, dysprosium, holmium, erbium, thulium, ytterbium, lutetium, including scandium and yttrium, can be present in a zero valence or elemental state, or in an ionized or valence state associated in the art with the given element, and all forms are understood to be collectively included within the meaning of reference to said element. For example, reference to “lanthanum”, “an element such as lanthanum”, “a composition comprising lanthanum”, and the like, it is understood that the reference inclusive any or all forms of lanthanum such as La°, La+2, and La+3. It is further understood that a reference to any given rare earth element is inclusive of all isotopic forms of the element.

As used herein, the terms “heavy rare earth element” and “HREE”, in the context of the present disclosure, can be used interchangeably and refer to one or more element selected from dysprosium, erbium, holmium, lutetium, thulium, ytterbium, and yttrium. It is to be understood that yttrium can be classified as a heavy rare earth element due to chemical properties and co-location with other HREEs in ores but can also be classified as a light rare earth element due to its lower atomic weight. However, in the context of segregation of REEs into only HREE and LREE (without separation of MREE), HREE refers to one or more element selected from dysprosium, erbium, holmium, lutetium, terbium, thulium, ytterbium, and yttrium.

As used herein, the terms “middle rare earth element” and “MREE”, in the context of the present disclosure, can be used interchangeably and refer to one or more element selected from europium, gadolinium, samarium, and terbium. In some aspects, these designations may differ slightly but are generally based on atomic weight.

As used herein, the terms “light rare earth element” and “LREE”, in the context of the present disclosure, can be used interchangeably and refer to one or more element selected from cerium, lanthanum, neodymium, and praseodymium. In some aspects, these designations may differ slightly but are generally based on atomic weight. However, in the context of segregation of REEs into only HREE and LREE (without separation of MREE), LREE refers to one or more element selected from cerium, europium, gadolinium, lanthanum, neodymium, praseodymium, samarium, and scandium.

As used herein, the term “total rare earth element” and “TREE”, in the context of the present disclosure, can be used interchangeably and refer to the total REE present in a disclosed composition or product of a disclosed process, method, or device, wherein the TREE comprises one or more of REE selected from lanthanum, cerium, praseodymium, neodymium, samarium, europium, gadolinium, terbium, dysprosium, holmium, erbium, thulium, ytterbium, lutetium, scandium and yttrium.

“Critical minerals” (CMs) as used herein include minerals important to national security and the economy. REEs are a subgroup of CMs. Like REEs, CMs are considered critical minerals due to their numerous industrial uses. As used in the context of the present disclosure, certain CMs may also be purified and concentrated using the disclosed process and include one or more of the non-rare earth elements selected from cobalt, gallium, germanium, hafnium, indium, lithium, magnesium, manganese, nickel, niobium, rhenium, rubidium, tantalum, tellurium, and zinc. However, the foregoing is merely exemplary and depending upon source from which the PLS is obtained, additional or alternative CMs may be obtained. It should be noted that the U.S. Geological Survey regularly makes a determination of minerals critical to the U.S. economy, with the last list having been made publicly available on or about Feb. 22, 2022 (e.g., see Federal Register, Vol. 87, No. 37, Thursday, Feb. 24, 2022, p. 10381-10382 and https://www.usgs.gov/news/national-news-release/us-geological-survey-releases-2022-list-critical-minerals, last accessed Nov. 30, 2023; each of which is incorporated by reference). As used in the context of the present disclosure, a CM may further include one or more mineral identified in the U.S. Geological Survey (e.g., aluminum).

“Acid mine drainage” (AMD) as used herein refers to acidic water that outflows from mines such as, for example, metal mines or coal mines. In one aspect, AMD intensifies in scale and scope when construction, mining, and other activities that disturb the earth occur in and around rocks containing sulfide minerals. AMD can have high concentrations of metal ions that can cause detrimental effects to aquatic environments, especially in combination with low pH. AMD from coal mines and other sources often contains trace amounts of REEs, as well. “Acid mine drainage” as understood within the definition herein can be aqueous effluent from mining operations, mill tailings, overburden from mining operations, excavations, acid process waste streams, seepages, and other aqueous flows having elevated levels of metal ions and/or anions. Acid mine drainage is characterized by the presence of metals such as iron, manganese, aluminum, cadmium, cobalt, copper, lead, magnesium, molybdenum, nickel, zinc, and others. Acid mine drainage may also include undesirable anions such as sulfate, fluoride, nitrate and chloride. As used in the present application, “mine” is understood to mean active, inactive or abandoned mining operations for removing minerals, metals, ores or coal from the earth. Environmental regulations promulgated by the Environmental Protection Agency under CAA, RCRA, and CERCLA, as well as those promulgated by state and local authorities, mandate that the concentration of certain minerals and metals in specific aqueous effluents be less than the established regulatory levels.

“AMD precipitate” (AMDp) as used herein refers to a byproduct of AMD treatment. In one aspect, AMDp contains REEs but may also contain gangue metals such as, for example, iron and aluminum. In one aspect, AMDp contains from about 0.06% to about 0.1% REE. As used herein, “enriched AMD precipitate” (eAMDp) refers to an AMD product having from about 0.1% to about 5% REE on a dry weight basis. In another aspect, eAMDp has a lower gangue metal content then AMDp.

A “feedstock” as used herein is a raw material processed to recover REEs and other valuable components (e.g., CMs). A feedstock may be too toxic to release into the natural environment and, in one aspect, the disclosed process can remove commercially valuable components from the feedstock while simultaneously rendering the feedstock suitable for environmental release.

As used herein, “contacting” refers to the act of touching, making contact, or of bringing substances into immediate proximity.

As used herein, “filtering” or “filtration” refers to a mechanical method to separate solids from liquids by passing the feed stream through a porous sheet such as a paper, ceramic or metal membrane, which retains the solids and allows the liquid to pass through. This can be accomplished by gravity, pressure or vacuum (suction). The filtering effectively separates the sediment and/or precipitate from the liquid.

As used herein, “biochar” refers to a carbon-rich material obtained by the pyrolysis of biomass. Biomass can include agricultural waste, animal manure, wood products, plant residues, and other organic waste.

Unless otherwise specified, temperatures referred to herein are based on atmospheric pressure (i.e., one atmosphere).

### B. ABBREVIATIONS

AH Appalachian hardwood
AMD acid mine drainage
CM critical minerals
EDS energy dispersive spectroscopy
SEM scanning electron microscope
SW softwood
WCC wood chip and chicken litter

### C. Introduction

REEs and other critical minerals can be found in minerals such as silicates (cerite, allanite), phosphates (monazite), carbonates (bastnasite), oxides (fergusomite, samarskite), and halides (yttrocerite) and have proven to be vital in science and technology areas such as metallurgy and medicine due to their unique physical and chemical. Lanthanum, for example, is an important constituent in the manufacture of optical glasses, batteries, ceramics, and alloys in either its pure form or in combination with other elements. However, the recovery of REEs is known to be complex. Commonly used methods such liquid-liquid extraction (Alcaraz et al., 2022) and leaching (Abhilash et al., 2014), are expensive and not environmentally friendly due to the high chemical consumption and waste discharged to the environment (Quijada-Maldonado & Romero, 2021).

Adsorption has the potential to provide an effective method for extracting lanthanum due to its low cost, less environmental impact, relatively high selectivity, relative simplicity, and efficiency compared to conventional methods. One material with good adsorption capacity is biochar. Biochar is a carbon-rich substance obtained by the pyrolysis of biomass (i.e., agricultural waste, animal manure, wood product, and other organic waste) at high pyrolysis temperatures under an inert environment. Biochar has a porous structure, is relatively low cost to obtain, and has good environmental compatibility. It has stable, honeycomb-like carbonaceous structure. It is comprised mainly of carbon, oxygen, and ash with minerals of numerous pore sizes, and its chemical composition may vary based on the source of the biomass and pyrolysis conditions. Additionally, depending on the source and the processing conditions, biochar samples can comprise different functional groups. The presence of these functional groups can the adsorption of different elements such as aluminum, copper, manganese, lead, and cadmium. Biochars have similar adsorption mechanisms to activated carbon and have the potential to transform contaminants into composites and participate through surface interaction. This adsorption mechanism is also based on the negative surface of the biochar attracting positive ions. The sorption mechanisms for metal ions could either be complexation, electrostatic attraction, or cation exchange. Micropores in biochars can account for their adsorption capacity and surface area while the mesopores can be associated with liquid-solid adsorption, and the macropores can be associated with hydrology, bulk soil structure, aeration, and movement. Disclosed herein is a method for the recovery of critical minerals, such as REEs, in a more cost effective and environmentally sustainable manner compared to traditional methods of critical mineral recovery. This method can address issues present in traditional REE production processes (e.g., solvent extraction), which are typically characterized by high solvent usage, complex separation schemes, and high energy consumption.

D. DISCUSSION

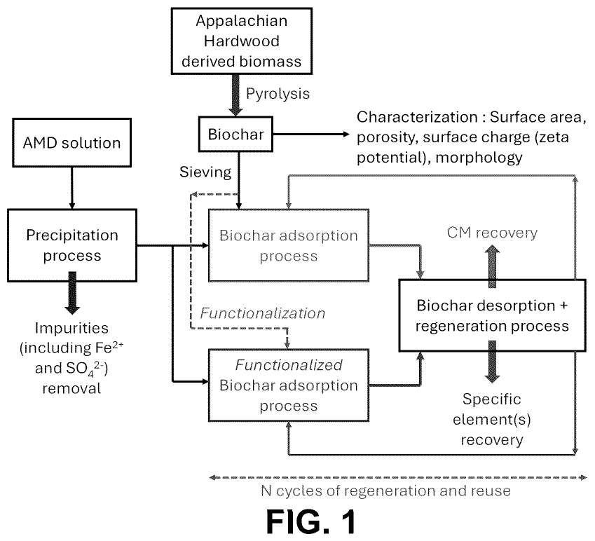

In one aspect, the present disclosure relates to a method for recovering critical minerals (CMs) from a solution, the method comprising: (a) providing a CM solution comprising at least one critical mineral and water; (b) contacting the CM solution with an acid or a base in an amount sufficient enough to adjust the pH to a value of about 2 to about 7; (c) contacting the CM solution with a first modified biochar, forming a first saturated biochar; and (d) desorbing the first saturated biochar, thereby forming a first CM precipitate, a first stripped biochar, and a first aqueous phase. In one aspect, the method can comprise steps outlined in the flow chart of FIG. 1. In another aspect, the CM solution can be contacted with an acid or a base in an amount sufficient enough to adjust the pH of the solution to a value of about 2 to about 7, about 2 to about 6, about 2 to about 4, about 3 to about 7, about 4 to about 7, or about 4 to about 6.

In one aspect, in order to adjust the pH, the CM solution can be contacted with an acid such as an organic acid (e.g., oxalic acid), an inorganic acid (e.g., hydrochloric acid, nitric acid, sulfuric acid, phosphoric acid), or any combination thereof. In another aspect, in order to adjust the pH, the CM solution can be contacted with a base such as an organic base (e.g., ammonium acetate), an inorganic base (e.g., sodium hydroxide, potassium hydroxide, calcium hydroxide, ammonium hydroxide,), or any combination thereof.

Desorbing the biochar can be performed via a variety of methods, such as thermal regeneration, chemical regeneration, microwave-assisted regeneration, or a combination thereof. In another aspect, the biochar can be desorbed using chemical regeneration, microwave-assisted regeneration, or a combination thereof. Chemical regeneration can include solvent-based regeneration comprising contacting the saturated biochar with a desorbent such as an inorganic acid (e.g., HCl, HNO₃, H₂SO₄). The inorganic acid can have a concentration of less than about 1 M, less than about 0.5 M, or less than about 0.1 M. In another aspect, the inorganic acid can have a concentration of about 0.01 M to about 1 M, about 0.01 M to about 0.5 M, or about 0.01 M to about 0.1 M. Microwave regeneration (microwave-assisted regeneration) can comprise selective heating of a saturated biochar. This can be done by heating the saturated biochar using microwave irradiation. The conditions under which the microwave radiation is applied (e.g., period of time, frequency, power) can be selected, in one aspect, to both maximize the desorption of any CMs adsorbed onto the biochar and maximize regeneration of the biochar. Examples of periods time include from about 1 second to about 10 minutes, from about 0.5 minutes to about 10 minutes, from about 0.5 minutes to about 8 minutes, or from about 1 minute to about 5 minutes.

The source of microwave radiation can be, for example, a commercially available microwave oven. In contrast to traditional bulk heating and regeneration, microwave regeneration can use less energy and reduce the biochar's loss in adsorption capacity following regeneration.

In one aspect, the CM solution can be formed from an AMD feedstock. The CM solution can comprise the AMD feedstock and a solvent, such as water. Prior to contacting the CM solution with an acid or a base to adjust the pH, the CM solution can be treated to remove impurities, such as iron and/or sulfate. In one aspect, the CM solution can be pretreated by contacting the CM solution with aluminum chloride with a solution pH of about 4 to about 6 or about 4 to about 5, removing impurities such as sulfate. The CM solution can also be treated to selectively precipitate impurities, such as iron. In one aspect, precipitation of impurities such as iron can be performed at low pH values of below about 5 or from about 2.5 to about 5. After pretreatment steps, the CM solution can have a sulfate concentration (parts by mass of sulfate in 100 parts by mass of the solution) of less than about 5%, less than about 4%, less than about 3%, less than about 2% or less than about 1%. In another aspect, the CM solution can have a sulfate concentration of 0.01% to about 5%, 0.01% to about 4%, 0.01% to about 3%, 0.01% to about 2%, about 2% to about 5%, about 1% to about 3%, or about 1% to about 2%. In another aspect, the CM solution can be essentially sulfate-free: i.e., a sulfate concentration of less than 0.01%. After pretreatment steps, the CM solution can have an iron concentration (parts by mass of iron in 100 parts by mass of the solution) of less than about 5%, less than about 4%, less than about 3%, less than about 2% or less than about 1%. In another aspect, the CM solution can have an iron concentration of 0.01% to about 5%, 0.01% to about 4%, 0.01% to about 3%, 0.01% to about 2%, about 2% to about 5%, about 1% to about 3%, or about 1% to about 2%. In another aspect, the CM solution can be essentially iron-free: i.e., an iron concentration of less than 0.01%.

A modified biochar can refer to a biochar that has undergone physical modification (e.g., particle size reduction and/or selective particle size selection) and/or chemical modification (e.g., the addition of functional groups). Modified biochar can be produced from a variety of biomass sources, such as agricultural waste (e.g., chicken litter), animal manure, wood products (e.g., softwood, hardwood, wood chips), plant residues, and other organic waste. In one aspect, the modified biochar can be produced from multiple varieties of biomass. The modified biochar can be produced by heating a biomass source in a reaction vessel at elevated temperatures (e.g., in the range of about 400° C. to about 1000° C.) in a low-oxygen environment (e.g., less than 0.1 psi partial pressure of oxygen). After the heating step, the biochar can be sieved to achieve a relatively uniform particles size and/or ground, crushed, milled, and the like to a desired particle size. Chemical modifications of the biochar can include acid treatment (e.g., acid wash); alkaline washing; and treatment with oxidizing agents, metal oxides, steam, or a gas. The modified biochar can be functionalized with at least one functional group selected from a carboxyl group, a hydroxy group, a peptide, and an amine. The modified biochar can comprise a variety of different types of functional groups or comprise primarily one type of functional group. In one aspect, the biochar can be functionalized to have an affinity to specific CMs or REEs or a more narrow subset of CMs or REEs, such as heavy REEs, light REEs, or middle REEs.

The modified biochar can be characterized by a variety of chemical and physical properties. In one aspect, the modified biochar can have a carbon content of at least about 60 wt %, at least about 70 wt %, at least about 80 wt %, or at least about 90 wt %. In another aspect, the modified biochar can have a carbon content of about 60 wt % to about 99 wt %, about 60 wt % to about 96 wt %, about 60 wt % to about 90 wt %, about 60 wt % to about 80 wt %, about 60 wt % to about 70 wt %, about 70 wt % to about 96 wt %, or about 80 wt % to about 96 wt %. In another aspect, the modified biochar can have a surface area of about 60 m²/g to about 1000 m²/g, about 60 m²/g to about 800 m²/g, about 60 m²/g to about 600 m²/g, about 60 m²/g to about 400 m²/g, about 60 m²/g to about 200 m²/g, about 200 m²/g to about 1000 m²/g, about 400 m²/g to about 1000 m²/g, about 600 m²/g to about 1000 m²/g, about 800 m²/g to about 1000 m²/g, about 200 m²/g to about 600 m²/g, about 200 m²/g to about 800 m²/g, or about 400 m²/g to about 800 m²/g. In another aspect, the modified biochar can have an adsorption capacity of about 1 mg/g to about 200 mg/g, about 20 mg/g to about 200 mg/g, about 40 mg/g to about 200 mg/g, about 60 mg/g to about 200 mg/g, about 80 mg/g to about 200 mg/g, about 100 mg/g to about 200 mg/g, about 120 mg/g to about 200 mg/g, about 140 mg/g to about 200 mg/g, about 160 mg/g to about 200 mg/g, about 180 mg/g to about 200 mg/g, about 1 mg/g to about 200 mg/g, about 1 mg/g to about 180 mg/g, about 1 mg/g to about 160 mg/g, about 1 mg/g to about 140 mg/g, about 1 mg/g to about 120 mg/g, about 1 mg/g to about 100 mg/g, about 1 mg/g to about 80 mg/g, about 1 mg/g to about 60 mg/g, about 1 mg/g to about 40 mg/g, about 1 mg/g to about 200 mg/g, about 20 mg/g to about 180 mg/g, about 20 mg/g to about 160 mg/g, about 20 mg/g to about 140 mg/g, about 40 mg/g to about 180 mg/g, about 40 mg/g to about 160 mg/g, about 40 mg/g to about 140 mg/g, about 1 mg/g to about 100 mg/g, about 100 mg/g to about 200 mg/g. In another aspect, the modified biochar can have a total pore volume of about 0.033 cm³/g to about 1 cm³/g, about 0.1 cm³/g to about 1 cm³/g, about 0.3 cm³/g to about 1 cm³/g, about 0.3 cm³/g to about 1 cm³/g, about 0.5 cm³/g to about 1 cm³/g, about 0.7 cm³/g to about 1 cm³/g, about 0.033 cm³/g to about 0.7 cm³/g, about 0.033 cm³/g to about 0.5 cm³/g, about 0.033 cm³/g to about 0.3 cm³/g, or about 0.033 cm³/g to about 0.1 cm³/g,. In another aspect, the modified biochar can have a zeta potential of about −5 Mv to about −60 Mv, −5 Mv to about −50 Mv, −5 Mv to about −40 Mv, −5 Mv to about −30 Mv, −5 Mv to about −20 Mv, −15 Mv to about −60 Mv, −25 Mv to about −60 Mv, −35 Mv to about −60 Mv, −45 Mv to about −60 Mv, −15 Mv to about −50 Mv, −15 Mv to about −40 Mv, or about −25 Mv to about −50 Mv.

In one aspect, the method steps disclosed herein can remove the majority of the CMs included in the CM solution in a single pass (i.e., step (a) through step (d), where the first CM precipitate can comprise the majority of the CMs that were present in the CM solution). However, depending on the chemical and physical modifications of the modified biochar, CMs can also be selectively precipitated from the CM solution. For example, the first modified biochar can be configured to selectively precipitate aluminum from the CM solution. The first aqueous phase may then comprise CMs other than aluminum (though it may still contain trace amounts of aluminum). The first aqueous phase can then be treated in a similar manner with a second biochar to either precipitate the remaining CMs or selectively precipitate other CMs, such as manganese. In this way, the methods disclosed herein can be iterative, where an aqueous phase formed by the desorbing step can be provided as a new CM solution for precipitating/recovering CMs from. The method can be repeated until a predetermined stopping point (e.g., 10 cycles of the method, desired CMs precipitated, little to no CMs remaining in the final aqueous phase, and the like).

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

### E. Aspects

The following listing of exemplary aspects supports and is supported by the disclosure provided herein.
Aspect 1. A method for recovering critical minerals (CMs) from a solution, the method comprising: (a) providing a CM solution comprising at least one critical mineral and water; (b) contacting the CM solution with an acid or a base in an amount sufficient enough to adjust the pH to a value of about 2 to about 7; (c) contacting the CM solution with a first modified biochar, forming a first saturated biochar; and (d) desorbing the first saturated biochar, thereby forming a first CM precipitate, a first stripped biochar, and a first aqueous phase.
Aspect 2. The method of aspect 1, wherein the CM solution comprises aluminum, manganese, cobalt, magnesium, lithium, a rare earth element, or a combination thereof.
Aspect 3. The method of aspect 1, wherein the first CM precipitate comprises aluminum, manganese, cobalt, magnesium, lithium a rare earth element, or a combination thereof.
Aspect 4. The method of aspect 1, wherein the first CM precipitate comprises aluminum, manganese, cobalt, magnesium, lithium, or a combination thereof.
Aspect 5. The method of aspect 1, wherein the first aqueous phase comprises cobalt, manganese, a rare earth element, or a combination thereof.
Aspect 6. The method of any one of aspects 2-5, wherein the rare earth element comprises yttrium, lanthanum, cerium, praseodymium, neodymium, samarium, europium, gadolinium, terbium, dysprosium, holmium, erbium, thulium, ytterbium, lutetium, or any combination thereof.
Aspect 7. The method of any one of aspects 1-6, wherein the pH of the CM solution is adjusted to a value of about 4 to about 6.
Aspect 8. The method of any one of aspects 1-7, wherein the CM solution is contacted with an acid selected from an organic acid, an inorganic acid, and any combination thereof.
Aspect 9. The method of any one of aspects 1-8, wherein the CM solution is contacted with a base selected from an organic base, an inorganic base, and any combination thereof.
Aspect 10. The method of any one of aspects 1-9, wherein the CM solution is contacted with an acid selected from hydrochloric acid, nitric acid, sulfuric acid, phosphoric acid, oxalic acid, and any combination thereof.
Aspect 11. The method of any one of aspects 1-10, wherein the CM solution is contacted with a base selected from sodium hydroxide, ammonium hydroxide, potassium hydroxide, calcium hydroxide, ammonium acetate, and any combination thereof.
Aspect 12. The method of any one of aspects 1-11, wherein the CM solution has been pretreated to reduce the presence of at least one impurity, wherein the at least one impurity is selected from iron and sulfate.
Aspect 13. The method of aspect 12, wherein the CM solution has a sulfate concentration of less than about 2%.
Aspect 14. The method of aspect 12, wherein the CM solution has a sulfate concentration of 0.01% to about 2%.
Aspect 15. The method of aspect 12, wherein the CM solution is sulfate-free.
Aspect 16. The method of any one of aspects 12-15, wherein the CM solution has an iron concentration of less than about 2%.
Aspect 17. The method of any one of aspects 12-15, wherein the CM solution has an iron concentration of 0.01% to about 2%.
Aspect 18. The method of any one of aspects 12-15, wherein the CM solution is iron-free.
Aspect 19. The method of any one of aspects 1-18, wherein the modified biochar has a carbon content of at least about 60 wt %.
Aspect 20. The method of one of aspects 1-, wherein the modified biochar has a carbon content of about 60 wt % to about 96 wt %.
Aspect 21. The method of one of aspects 1-20, wherein the modified biochar is functionalized with at least one functional group selected from a carboxyl group, a hydroxy group, a peptide, and an amine.
Aspect 22. The method of one of aspects 1-21, wherein the modified biochar has a surface area of about 60 m²/g to about 1000 m²/g.
Aspect 23. The method of one of aspects 1-22, wherein the modified biochar an adsorption capacity of about 1 mg/g to about 200 mg/g.
Aspect 24. The method of one of aspects 1-23, wherein the modified biochar has a zeta potential of about −5 Mv to about −60 Mv.
Aspect 25. The method of one of aspects 1-24, wherein desorbing the saturated biochar is performed via thermal regeneration, chemical regeneration, microwave-assisted regeneration, or a combination thereof.
Aspect 26. The method of one of aspects 1-25, wherein the CM solution is a first CM solution; and the method is iterative with the first aqueous phase being provided as a second CM solution for recovering CMs from the second CM solution.
Aspect 27. The method of one of aspects 1-26, wherein the CM solution is a first CM solution; and the method is iterative wherein an aqueous phase formed by the desorbing step is provided as an additional CM solution for recovering CMs from the additional CM solution.
Aspect 28. The method of one of aspects 1-27, further comprising: (a) separating the first aqueous phase from the first stripped biochar and the first CM precipitate; (b) contacting the first aqueous phase with a second modified biochar, thereby forming a second saturated biochar; and (c) desorbing the second saturated biochar, thereby forming a second CM precipitate, a second stripped biochar, and a second aqueous phase.
Aspect 29. The method of aspect 28, wherein the second CM precipitate comprises manganese, cobalt, a rare earth element, or a combination thereof.
Aspect 30. The method of aspect 28, wherein the second CM precipitate comprises manganese.
Aspect 31. The method of aspect 28, wherein the second aqueous phase comprises cobalt, a rare earth element, or a combination thereof.
Aspect 32. The method of one of aspects 28-31, further comprising: (a) separating the second aqueous phase from the second stripped biochar and the second CM precipitate; (b) contacting the second aqueous phase with a third modified biochar, thereby forming a third saturated biochar; and (c) desorbing the third saturated biochar, thereby forming a third CM precipitate, a third stripped biochar, and a third aqueous phase.
Aspect 33. The method of aspect 32, wherein the third CM precipitate comprises cobalt, a rare earth element, or a combination thereof.
Aspect 34. The method of aspect 32 or aspect 33, wherein the third aqueous phase is essentially free of critical minerals.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### F. Examples

### 1. Biochar Adsorption for Lanthanum Recovery

In this Example, the use of biochar as an effective adsorbent for lanthanum recovery from an aqueous solution is examined. It was targeted to develop insight into biochar's adsorption capacity and the applicability of this approach toward developing more sustainable recovery processes. The tests were initially conducted with a synthetic solution; and later applied on multi rare earth-containing system with impurity metals.

Materials and Methods-Feedstock and Biochar Preparation. Tests were performed with a synthetic solution prepared by high purity (>99%) lanthanum (III) nitrate hexahydrate purchased from Sigma Aldrich. Feedstocks with varying lanthanum content were prepared and used. Softwood (SW) forestry residue harvested from Northern California, a mixture of wood chips and chicken litter (WCC), and Appalachian hardwood (AH) collected in West Virginia were used as biomass sources. Biochars were produced via an optimized gasification process at different pyrolysis temperatures of 450° C., 700° C., and 675° C. with a heating rate of 20° C./min for 10 min. The biochars were then left to cool at room temperature for 12 hours, where it is then sieved to obtain a uniform particle size of 3 mm. Biochar samples were then further grounded to obtain<500 μm particle size and put inside the desiccator to avoid moisture adsorption Table 1 summarizes the biochar sources and properties.

TABLE 1
The biochar sources and properties at the time of production.

| | | Carbon | | Total | Bulk | |
|---|---|---|---|---|---|---|
| | | Organic, | Nitrogen, | Ash, | Density, | pH |
| Biochar | Source | % | % | % | lb/cu ft | Value |
| SW | Softwood | 85.3 | 0.75 | 5.9 | 9.3 | 9.58 |
| WCC | Wood chips | 41.18 | 3.88 | 33.1 | 9.4 | 9.4 |
| | and | | | | | |
| | chicken litter | | | | | |
| AH | Appalachian | 82.6 | 0.76 | 9.7 | 9.1 | 9.58 |
| | hardwood | | | | | |

Materials and Methods-Lanthanum Adsorption Tests. Adsorption experiments were conducted by mixing 50 mg biochar with 50 ml La-containing feedstock solution. Several operating parameters were investigated throughout the study to determine the optimal adsorption conditions. The effect of pH on the recovery of lanthanum was tested with values ranging from 2-6. This pH range was selected due to the potential for lanthanum to precipitate as lanthanum hydroxide in an alkaline media. The pH was adjusted using 0.5M HCl and 0.5M NaOH, and the solution was agitated for 24 hours. Contact time is also an important factor in evaluating the efficiency of adsorbents. The effect of contact time was studied at time intervals of 10 min, 30 min, 480 min, and 1440 min while keeping the solution pH at 5. The effect of lanthanum initial concentration was studied, and experiments were conducted with solutions containing 0.2 ppm, 12 ppm, 72 ppm, 230 ppm, 640 ppm, and 1200 ppm lanthanum. All the experiments were per-formed at room temperature, and the agitation rate was kept constant at 120 rpm. When the tests were completed, the solution was filtered using a 0.22 μm membrane filter, and aqueous samples were analyzed with ICP-MS to detect the elemental composition. On the other hand, separated biochar was subjected to characterization tests.

The elemental uptake, the adsorption capacity at equilibrium, and the amount of lanthanum adsorbed at changing conditions were calculated using the following equations, the uptake percentage (U %), the amount of lanthanum ions adsorbed at time t (qt in mg/g), and the amount of lanthanum ions desorbed at equilibrium (qₑ in mg/g).

$$U \% = \frac{( {C}_{0} - {C}_{e} ) 100 \%}{{C}_{0}} \qquad ( 1 )$$

$${q}_{t} = \frac{( {C}_{0} - {C}_{t} ) V}{W} \qquad ( 2 )$$

$${q}_{e} = \frac{( {C}_{0} - {C}_{e} ) V}{W} \qquad ( 3 )$$

where C₀, Cₜ, and Cₑ are in mg/L and represent the initial concentrations, time-dependent concentration, and equilibrium concentrations of lanthanum ions, respectively. V is the total volume of the lanthanum solution in mL, and W is the weight of the biochars in mg.

After adsorption, desorption tests were carried out. Depending on the biochar composition and structure, different regeneration methods can be used (Alsawy et al., 2022). In this Example, lanthanum desorption tests were performed using three reagents with varying concentrations, such as HCl (0.2 M, 0.5 M), NaOH (0.2 M, 0.5 M, and 2 M), and HNO₃ (0.01 M, 0.2 M, and 0.5M) and the desorption rate was calculated based on the equation given below.

$${q}_{d e} = \frac{{C}_{d} \times V}{W} \qquad ( 4 )$$

$$D \% = \frac{{q}_{d e}}{{q}_{e}} \times 100 \% \qquad ( 5 )$$

where q_{de} (mg/g) and C_{d}(mg/L) represents the amount of lanthanum ions desorbed in solution and concentration of lanthanum ions desorbed in solution, respectively.

Materials and Methods-Characterization Studies. Zeta potential was performed to determine the surface charge on the biochars using the Malvern zeta sizer. For zeta potential measurements, SW, WCC, and AH biochars were first wet screened and grounded using an agate mortar and pestle and were sieved through 500 μm. Measurements were carried out at room temperature. 0.5 g of biochar sample was added to the electrolyte solution (1×10-3M KCL) and stirred using the electric shaker to obtain a uniform suspension. After 10 minutes of natural settling, 3 ml of the super-natant was collected and added to separate 50 ml beakers containing the electrolyte solution ranging from pH 2-pH 10 and was agitated for 5 minutes. The mixture was then allowed to settle for 2 minutes. 40 ml of the supernatant and supporting electrolyte was placed inside the ultra-bath for 120 seconds and was immediately subjected to zeta potential measurements. Each zeta potential measurement was an average of three duplicate measurements, and each separate test was an average of 100 automatically repeated tests.

Scanning electron microscopy (SEM) (JOEL JSM 7600F) was used to determine the biochars' morphology. Each biochar sample was prepared by coating with Gold/Palladium (Au/Pd) using the Denton Desk V sputter and carbon coater for 90 seconds before SEM characterization. This helps to reduce biochar's charging effect, even the distribution of the biochar on the surface of the pins, and for achieving high-quality SEM images. Brunaur-Emmett-Teller (BET) was used to determine the biochars' pore properties, N2 adsorption-desorption isotherm, and the biochars' pore size and surface area. Fourier Transform Infrared Spectroscopy (FTIR) was used to expose the functional groups present in these biochars, they are dried and put in the desiccator to avoid moisture. Grounded powders of the biochar samples were pressed flat against the diamond crystal surface of the FTIR, spectra were recorded using the Digital FTS 7000/UMA 600 Fourier Transform infra-red spectrometer, and the absorbance of each sample was measured from 4000 to 400 cm-1 using 128 scans per sample with a speed of 20 kHz and a resolution of 4 cm-1. The spectra were corrected using the surrounding air as the background spectrum in the range of 7.8-8.2. FTIR Results were analyzed using Varian resolution pro 640 software (version 5.1, Agilent, Santa Clara, CA, USA).

Results and Discussion-Characterization of Biochars Before Adsorption Tests.

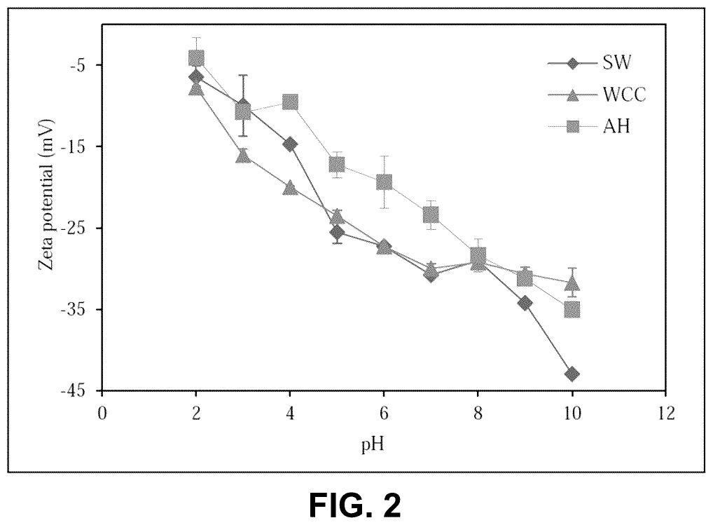

The zeta potential measurements of the three biochars exhibited a downward trend with increasing pH levels, possibly due to the degree of protonation of the hydroxyl and carboxyl groups present at each pH level (FIG. 2). This shows that the biochar carries a negative charge, the magnitude of which significantly increases as the pH increases. The values of the zeta potential for the three-biochar ranged from −4 mv to −43 mv, which shows a wide range of negative charges present on the surface of the biochars. With this negative charge on the surface of the biochars, La (III) is likely adsorbed on the surface via electrostatic attraction.

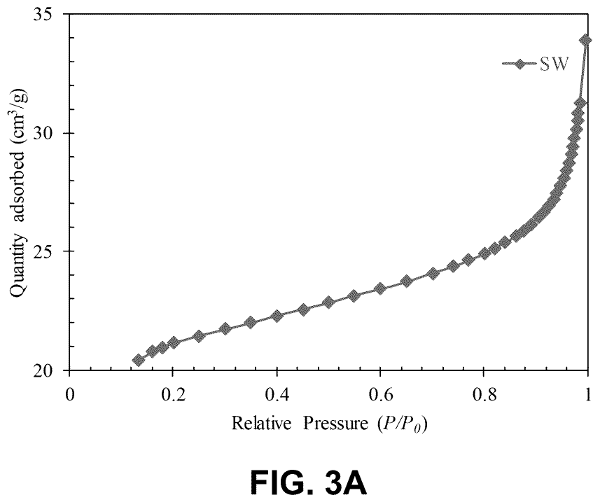

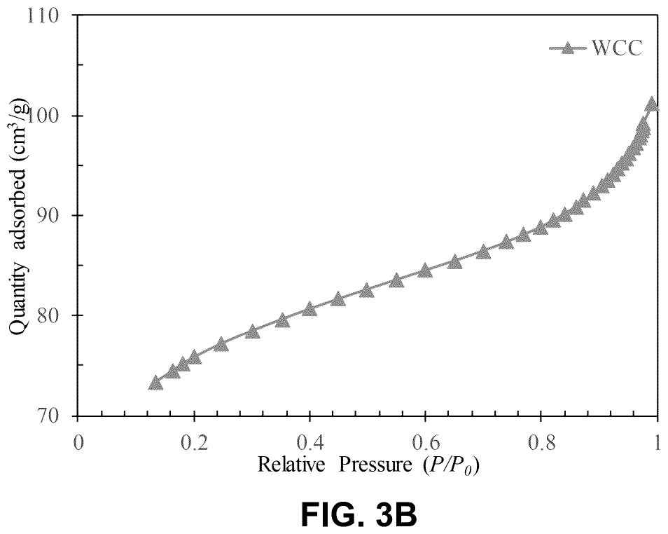

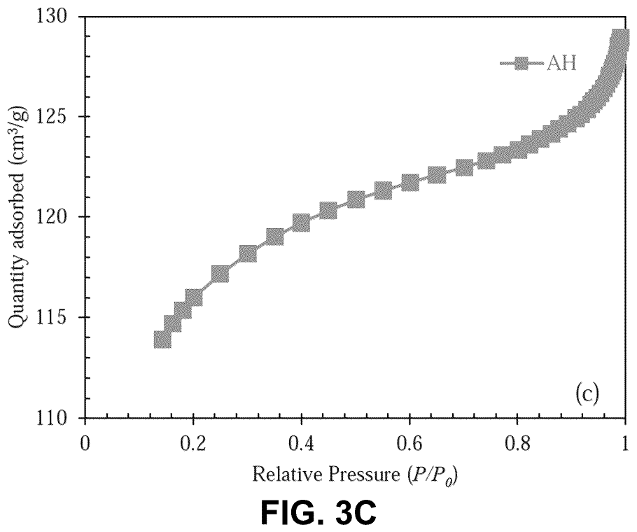

The BET analysis was used to determine the biochars' surface area and pore size distribution. The surface areas of SW (353 m2/g) and AH (255.08 m2/g) were significantly higher compared to that of WCC (62.45 m2/g). This can be attributed to the high pyrolysis temperature and the composition of the wood biomass at the time of production. According to the BDDT and IUPAC classification of pores (Thommes et al., 2015), the 77K N2 adsorption isotherms of SW, WCC, and AH were all type II and IV isotherm curves. The biochar, which is a mesoporous material, has pore diameters between 2 nm to 50 nm, as seen in Table 2, and the amount of quantity adsorbed increases with increasing relative pressure indicating the presence of mesopores which are likely to increase with increasing temperature (Wang et al., 2013; Chen et al., 2015) as shown in FIGS. 3A-3C. It can also be observed that adsorption began at low relative pressures, which may imply the presence of micropores in the biochar surfaces (Ramesh et al., 2014).

TABLE 2
Pore properties of biochars before lanthanum adsorption.

| | Surface Area, | Pore Diameter, | Pore Volume, |
|---|---|---|---|
| Biochar | m²/g | nm | cm³g⁻¹ |
| Softwood | 353 | 3.5233 | 0.0201 |
| Wood chip and | 62.45 | 6.635 | 0.0274 |
| chicken litter | | | |
| Appalachian | 255.08 | 4.39 | 0.0675 |
| hardwood | | | |

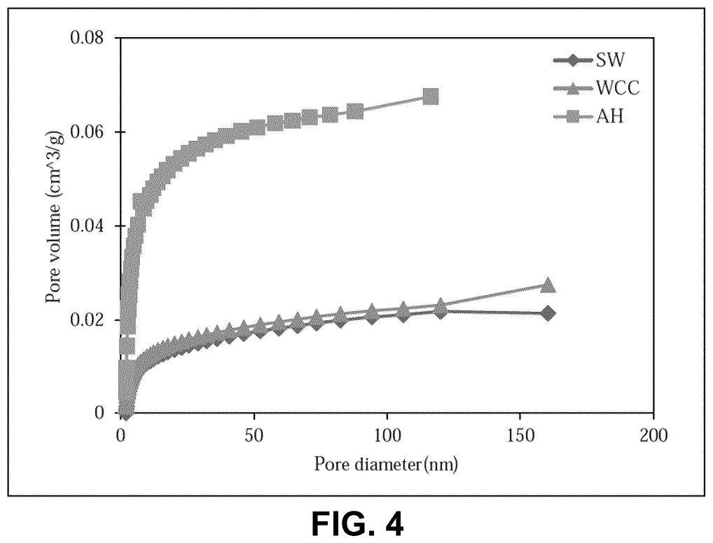

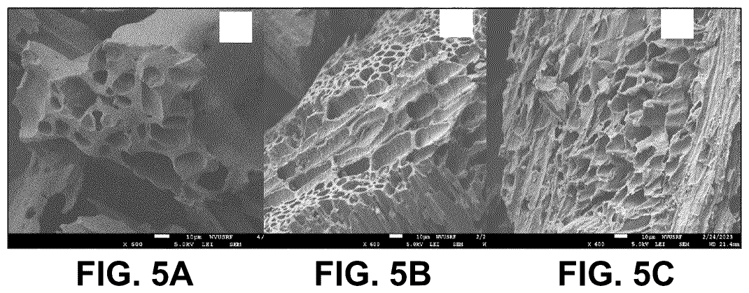

SEM was used to assess the morphology of the biochars before lanthanum adsorption. FIG. 5 shows that SW has smooth surfaces, whereas WCC and AH had rough and porous surfaces before lanthanum adsorption. These porous and rough surfaces agreed with the BET results given in Table 2 and the pore size distribution results shown in FIG. 4, which showed AH had a higher pore volume than WCC and SW and more lanthanum adsorption was likely expected in AH.

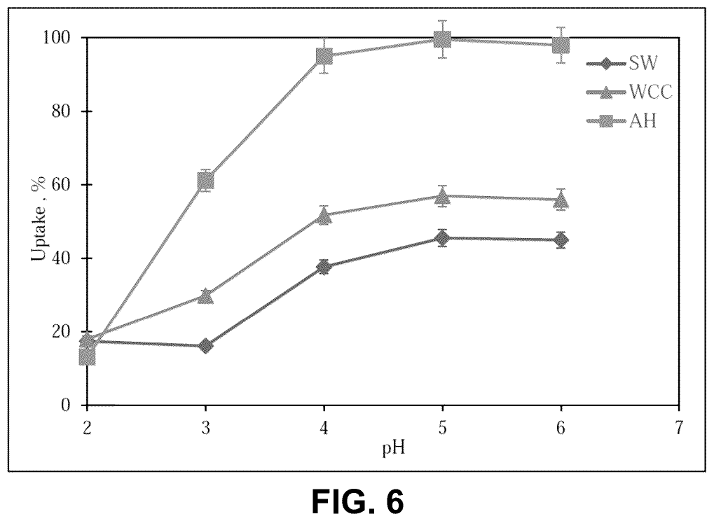

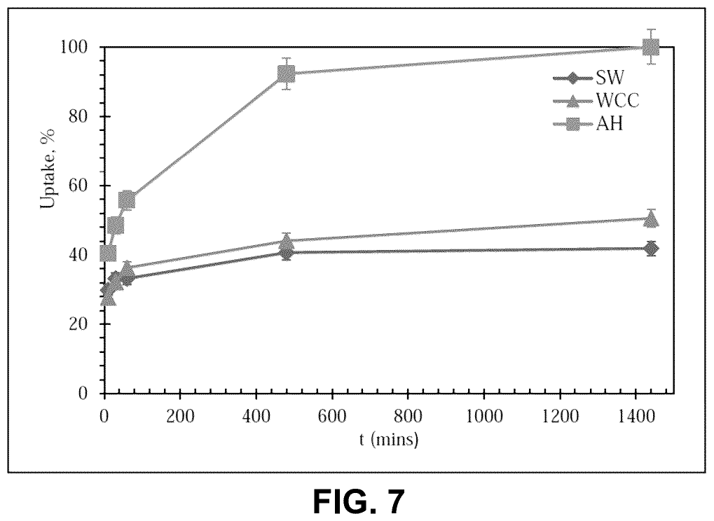

Adsorption-Desorption Tests Results. FIG. 6 shows the effect of pH on the lanthanum adsorption performance. pH is one of the most important operating parameters which impacts how well sorbates adhere to adsorbents. The maximum lanthanum uptake in the three biochars was exhibited at pH five. Therefore, it was selected as the pH level for the remaining study. AH showed a higher uptake than WCC and SW. Additionally, it can be observed that the large variation in the uptake percentage of the different biochars at various pH levels may be due to the diverse characteristics of the biochars. The test results performed at varying contact time are seen in FIG. 7. Lanthanum adsorption experiments were conducted at different contact times to observe the time required for the sorbents SW, WCC, and AH to reach equilibrium under the same conditions. It can be seen from the figure that the sorbents SW and WCC had almost attained equilibrium within a short period (10-60 minutes). This is evident by the fact that there are numerous sorption sites available at the initial stage of the adsorption process, which resulted in the rapid attachment of lanthanum to the bio-char surfaces; hence, at the latter stages is kept constant as adsorption occurs via attachment-controlled process due to the fewer available sorption sites (Pandey et al., 2014; Saha et al., 2010). AH, however, showed a noticeable variation in the contact times in the initial stages of adsorption com-pared to the other two biochars, attaining equilibrium with an uptake percentage above 90% within 8 h to 24 h.

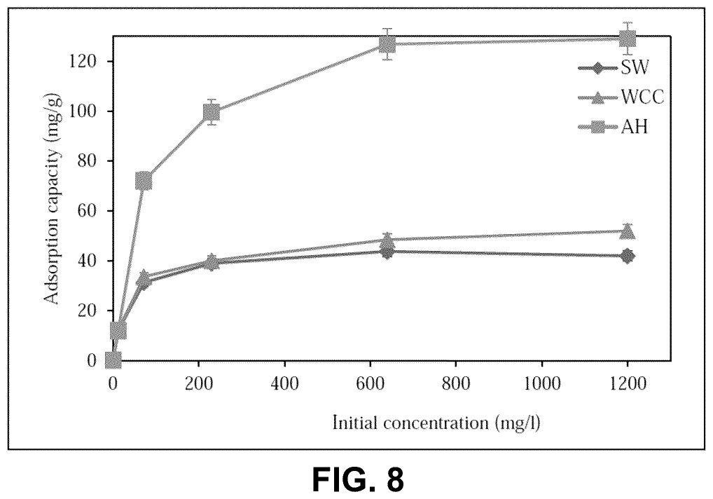

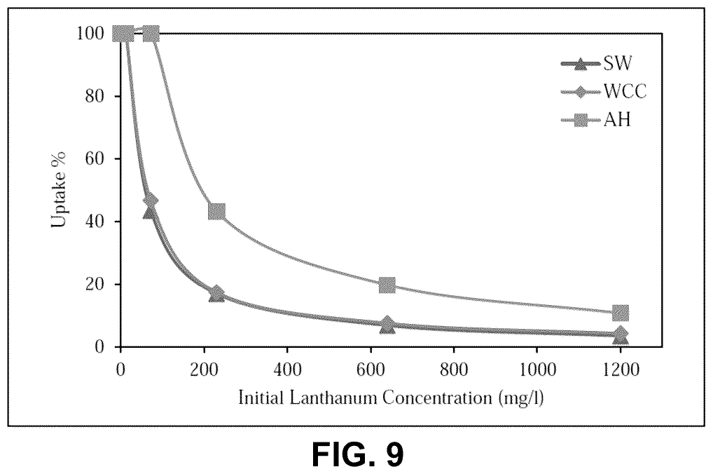

The effect of initial lanthanum concentrations on adsorption performance was investigated using a concentration range of 200 ppb to 1200 ppm. This showed the diverse removal efficiency of the biochars with lanthanum, even at ppb levels. FIG. 8 shows that the adsorption capacity of the biochars increased with increasing initial concentration; however, at a high initial lanthanum concentration of 640 ppm, WCC and AH showed little or constant adsorption compared to the initial stages (FIG. 9). This depicts that the adsorption capacity of the biochars was saturated due to the rapid adsorption in the initial stages. SW showed a similar adsorption capacity to WCC but significantly dropped after a high concentration of 640 ppm, showing the limited adsorption capacity of the biochar. Comparatively, AH had the maximum equilibrium adsorption capacity between the three biochars, followed by WCC and SW, with adsorption capacities of 129 mg/g, 52 mg/g, and 42.0 mg/g, respectively. AH has three times that of SW capacity and a noticeable difference compared to WCC. Although REEs are often found in lower concentrations (ppb levels) in most aqueous sources, their rapid adsorption on the biochars in the early stages demonstrates the favorable usability of the three biochars.

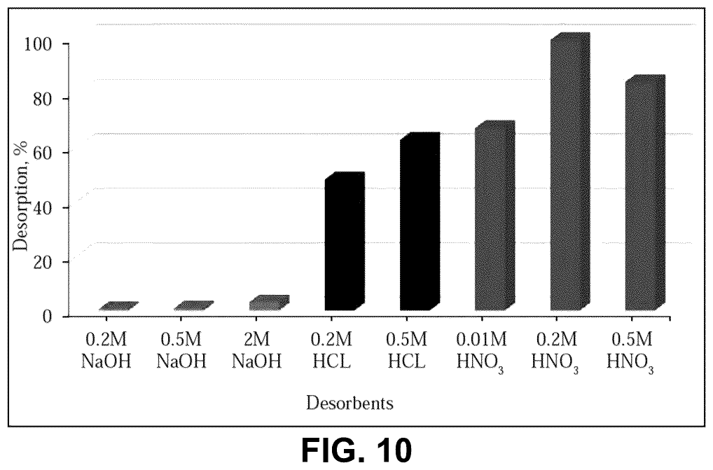

As shown in FIG. 10, HNO₃ exhibited a significantly higher desorption rate than HCl and NaOH at any given concentration. 0.2 M HNO₃ resulted in the highest desorption rate (99%), which is followed by 0.5 M HNO₃ (84%) and 0.01 M HNO₃ (67%). Between the HCl and NaOH, it can be seen from the same figure that HCl has a superior desorption capability than NaOH. However, it was also observed that 0.5 M HCl and 0.01 M HNO₃ have almost identical desorption rates. The AH biochar desorbed using 0.2 M HNO₃ was further used for the second, third, and fourth adsorption-desorption cycles in an effort to show the re-usability of AH. However, consequent cycles showed a drastic reduction in the adsorption capacities of AH from 72 mg/g to an average capacity of 4 mg/g. It can be said that the biochar pores were blocked, and the active sites were lost after the first cycle. This explains that the biochar structure could have also been destroyed, probably due to the use of nitric acid.

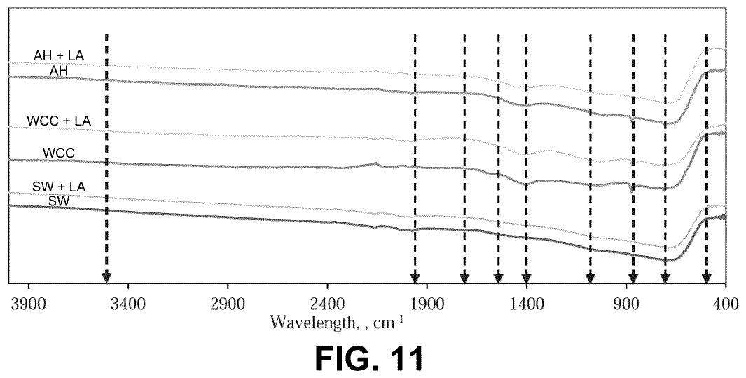

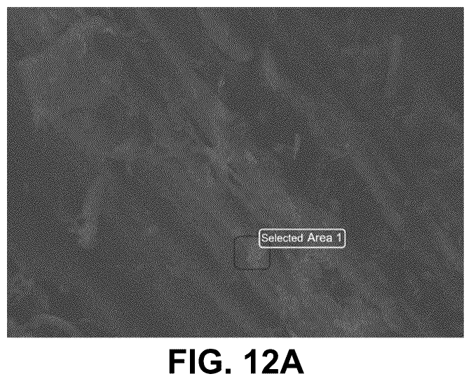

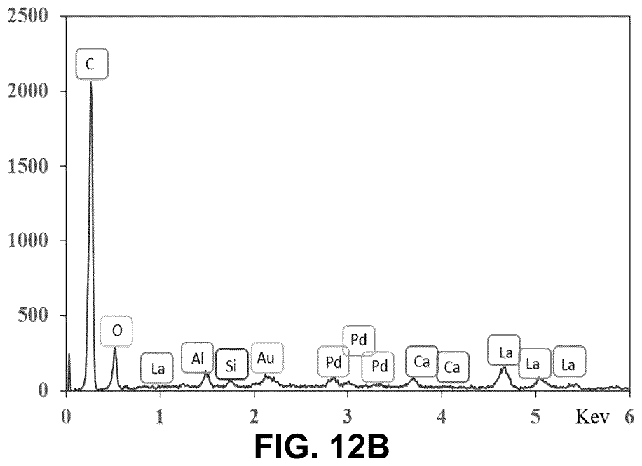

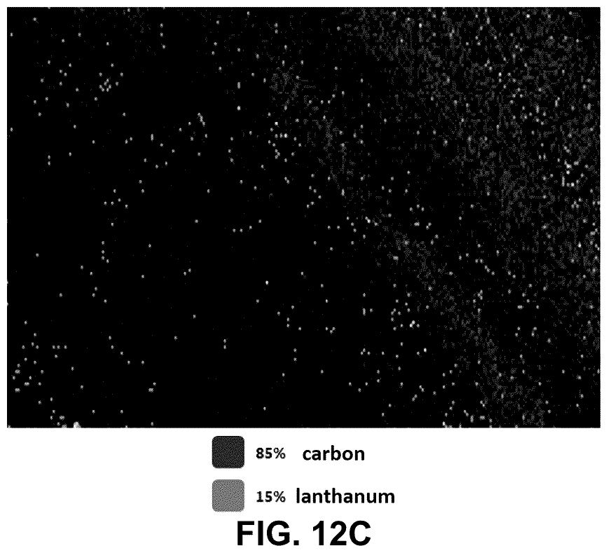

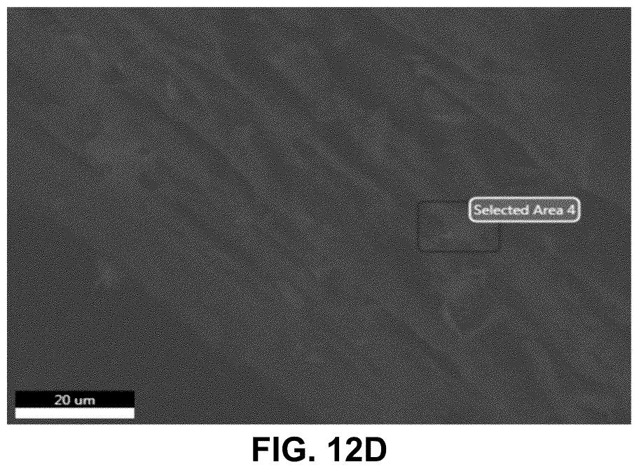

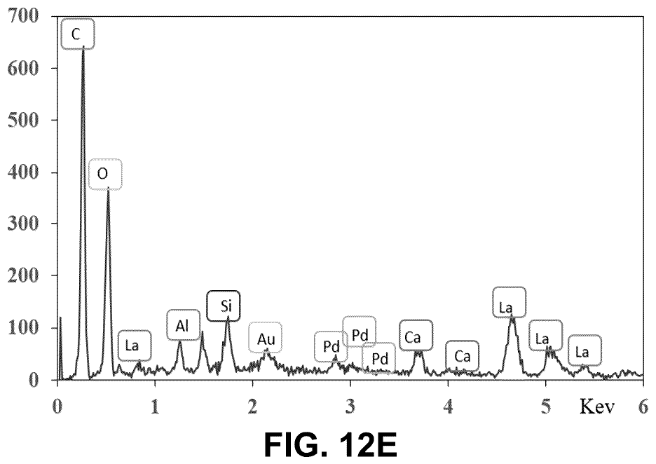

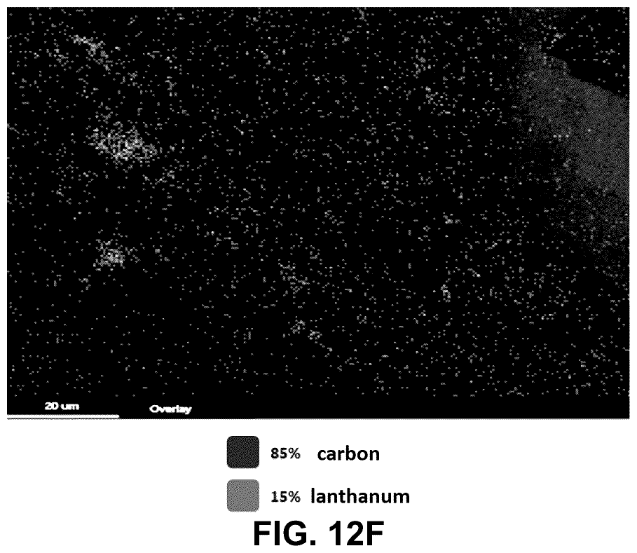

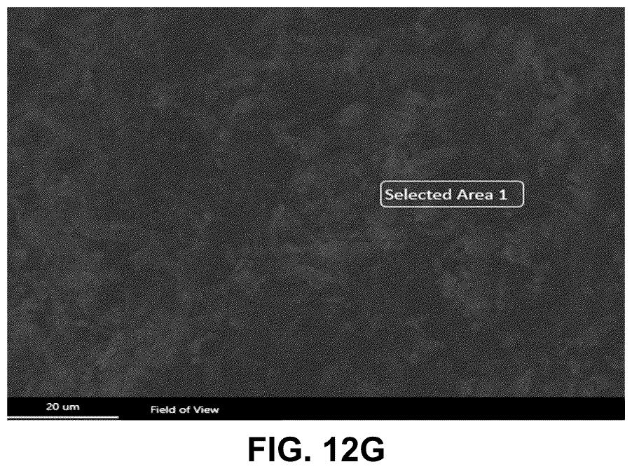

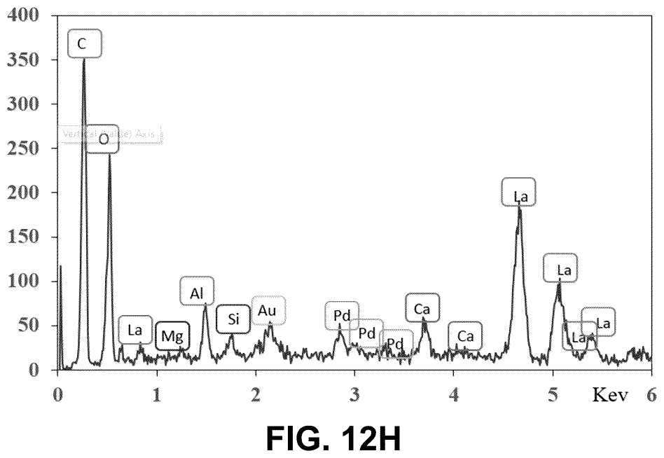

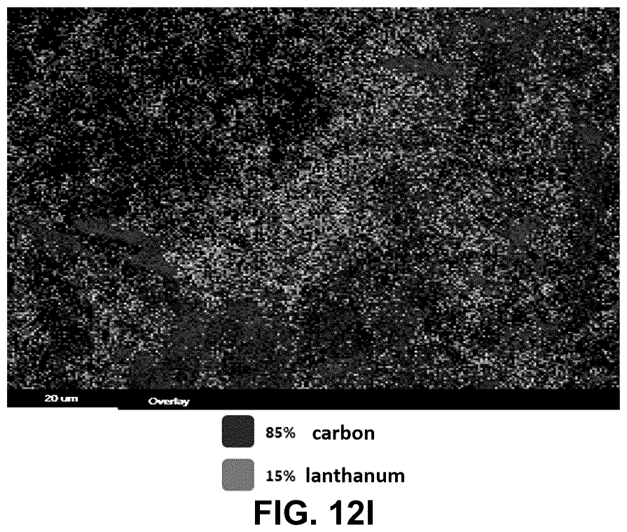

Characterization of Biochars Post Adsorption. FIG. 11 shows the FTIR spectra of the biochars used. It can be observed that the adsorption peaks of these biochars before and after adsorption are almost the same. FTIR spectra showed no significant peak and change in the band 3400-3900, where the hydroxyl group (—OH) is observed (Kołodyńska et al., 2018). However, at band 518 cm⁻¹, 713 cm⁻¹ and 867 cm⁻¹, there was a noticeable shift in the peak of WCC and AH after the adsorption of lanthanum, and this can be attributed to the presence of C—H bonds of aromatic groups (Li et al., 2019; Zhang et al., 2011). The band 1053 cm⁻¹ could also be attributed to the phenol group with stretching C═O vibrations (Tan et al., 2020; Zhao et al., 2021).1425 cm-1 may be attributed to the aliphatic hydrocarbons and alkenes (Zhao et al., 2021). The existence of the bands 1539 cm⁻¹ and 2180 cm⁻¹ may be due to the ether, carboxyl, and amide groups, respectively (Ding et al., 2016; Wang et al., 2020; Zhang et al., 2011). After lanthanum adsorption, the biochars' chemical composition and structure were determined using EDS analysis. Point analysis was performed and indicated peaks of carbon, oxygen, calcium, aluminum, gold, palladium, and lanthanum appeared dominant (FIGS. 12B, 12E, and 12H). The green dots on the map in FIGS. 12C, 12F, and 12I represent areas where lanthanum was dominant on the biochar surfaces, while the purple dots represent areas where carbon was dominant on the biochar surfaces. These findings were consistent with the experimental findings, which showed an adsorption capacity of 129.9 mg/g for AH was almost three times more than SW.

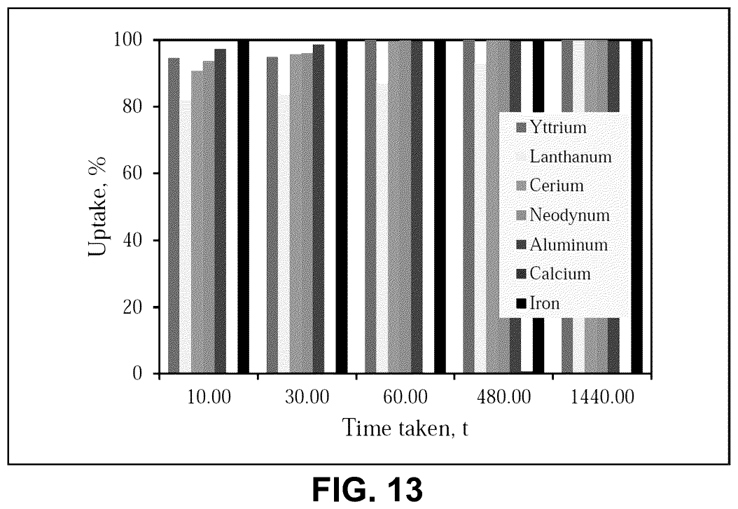

Mixed Element System Tests Results. In this study, it was also targeted to investigate the effect of competing ions and observe the applicability of biochar adsorption when the system is fairly crowded with HREE, LREEs, and impurity metals. A mixed system was prepared to represent the typical acid mine drainage composition due to adsorption being more favorable process in dilute REE solutions. The study examined the impact of contact durations, specifically at time intervals of 10 minutes, 30 minutes, 60 minutes, and 1440 minutes. The findings indicated that AH effectively adsorbed all REEs, aluminum, and iron in the system, with the exception of calcium, which was still fully present in the mixed solution after 24 hours (FIG. 13). No adsorption was seen for calcium at any test condition. This shows the low affinity of the biochar for calcium ions in solution, showing the adsorbent prefers higher valency elements. The LREE and HREE in the mixed system showed similar adsorption and the same uptake percentage when compared with each other as seen in FIG. 13. The uptake of REEs ranged between 40% to almost 70%. Lanthanum and yttrium showed the lowest adsorption compared to cerium, neodymium, terbium, and gadolinium. This shows that the biochar could not extract elements selectively but instead will interact and adsorb every element in the system. This, however, calls for functionalizing the biochar to achieve selectivity between metals and other competing ions.

Conclusions. It can be concluded biochar made from Appalachian hardwood was utilized to remove La (III) from the aqueous solution and showed the maximum adsorption capacity of 129 mg/g when compared to the other two biochars employed in this work, which demonstrated more than double their adsorption capabilities. After adsorption tests were done, 0.2M HNO₃ showed approximately a 100% desorption rate for La (III) when compared to other desorbents used in this study. The highest desorption rates achieved with NaOH and HCl were 3% and 62.5%, respectively. Even though nitric acid desorbed completely La (III) from biochar, it is also possible that biochar might lose its adsorption capacity for subsequent adsorption/desorption cycles. When the experimental system was expanded to multiple elements, it was observed that the biochar has tendency toward higher valence elements (3+) more than divalent elements (such as Ca, 2+). However, because no selectivity between 3+ elements was seen, biochar surface functionalization can be sought for higher efficiency.

2. Critical Mineral Extraction from Coal Acid Mine Drainage

This Example discusses the sustainable extraction of CMs from AMD to maximize the water reuse and resource recovery. The solid-phase extraction process has a high potential to replace current inefficient water treatment technologies (e.g., bulk chemical precipitation) and expensive and contaminating critical elements extraction approaches (e.g., leaching and solvent extraction). Most of these available separation techniques utilize harsh/expensive chemicals in large quantities, potentially introducing new waste into already polluted streams. Unlike these methods, the solid-phase extraction process can substantially decrease the volume of required solvents and reagents by providing a vast interactional environment for more efficient and effective chemical adsorption of desired species. Furthermore, the prospect of recovering elements from AMD is a promising possibility that could potentially offset AMD treatment costs.

Discussion and Preliminary Results. AMD consists of a varied concentration of metals such as iron, aluminum, magnesium, manganese, REEs, and the dominant anion, sulfate. The characteristics and chemical composition of AMD may vary widely according to site conditions such as weather, geomorphology, amount of waste materials (He et al., 2017; Lu et al., 2021). Vass et al. reported a systematic sample collection and analysis of more than 40 AMD treatment sites in Central Appalachia (CAPP) (Vass et al., 2019). A more detailed elemental composition of the AMD sample is given in Table 3.

TABLE 3
Average elemental content of the AMD samples collected from 40 sites
in Central Appalachia (Vass et al., 2019).

| Element | Al | Ca | Fe | Mg | Mn | Na | Cl | SO₄ |
|---|---|---|---|---|---|---|---|---|
| Concentration | 12.99 | 167.95 | 22.37 | 123.84 | 10.74 | 36.72 | 5.3 | 1090.94 |
| (mg/L) | | | | | | | | |

| Element | Y | Gd | Tb | Dy | Ho | Er | Tm | Yb | Lu |
|---|---|---|---|---|---|---|---|---|---|
| (Heavy REEs) | | | | | | | | | |
| Concentration | 46.69 | 12.39 | 1.95 | 10.57 | 1.95 | 4.99 | 0.81 | 3.89 | 0.71 |
| (μg/L) | | | | | | | | | |

| Element | Sc | La | Ce | Pr | Nd | Sm | Eu |
|---|---|---|---|---|---|---|---|
| (Light REEs) | | | | | | | |
| Concentration | 3.09 | 26.82 | 53.66 | 8.03 | 37.32 | 9.73 | 2.64 |
| (μg/L) | | | | | | | |

AMD samples collected from AllStar Ecology, LLC were characterized. The AMD samples have a pH range of 2.4-7.5 and electrical conductivity of 668-8610 μmhos/cm. Additionally, the chemical compositions of the AMD samples are similar to data reported in the literature on AMD sites in the Appalachian region. As Table 3 shows, critical minerals like Al, Mg and Mn are present in abundance (in mg/L range) across AMD sites, while the total REE content is ˜225 μg/L. Thus, there is enormous potential for recovering CM's especially Al, Mn and Mg from AMD, and could serve to supplement the domestic production of these important materials within US. Impurities, especially SO₄²⁻ (1000 mg/L) are present in concentrations which are orders of magnitude higher compared to the REE/CMs and therefore can be separated from AMD prior to the solid-phase biochar adsorption step to avoid competitive sorption.

The solid-phase extraction procedure is based on the adsorption of the desired species onto the surface of a given adsorbent. In solid-phase extraction, an effective adsorbent can be characterized by: (i) having a large surface area in order to achieve a high extraction capacity; (ii) being easily modifiable with functional groups; (iii) allowing for shape control in order to adapt the materials to different applications; and/or (iv) being durable and reusable. Over the last decade, researchers considered solid-phase extraction process as an alternative strategy for liquid-liquid extraction (solvent extraction) due to the following merits: (i) absence of emulsion, (ii) high preconcentration factor, (iii) low costs, (iv) low organic solvent consumption, (v) less processing time, (vi) simpler processing methods, (vii) ease of automation, and (viii) eco-friendly.

Of all developed sorbents, carbon-based sorbents proved to be the most cost-effective for removal of inorganic and organic pollutants from wastewater (Hu et al., 2018). Activated carbon is ideally suited for removing contaminants from water, but its production is costly and is derived from fossil fuel-based sources. The development of advanced adsorbents with multiple functions and enhanced performance has become an ongoing area of study, and biochar materials with a high intrinsic specific surface area have been evaluated as potential practical adsorbents. Biochar is a carbon-rich material obtained from the thermo-chemical or hydrothermal conversion of biomass under oxygen-limited conditions. It is a low-cost adsorbent that has recently attracted more interest due to its many potential environmental applications and advantages (Lee et al., 2020).

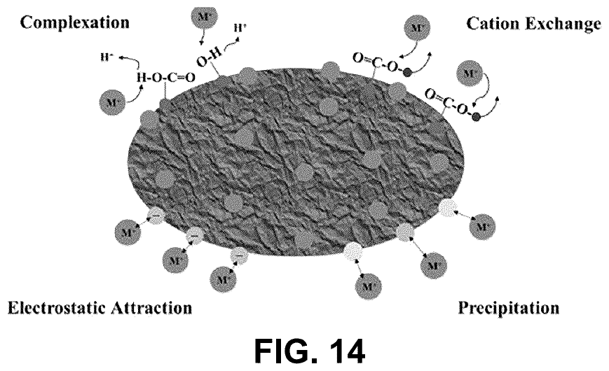

Adsorption of ions and ionic compounds on biochar may be explained through electrostatic attraction, complexation, ion exchange, and precipitation (FIG. 14). While the charges on the surface of biochar can control electrostatic attraction (physical adsorption), the fixation mechanism of ions by biochar is primarily dependent on the surface pore size and oxygen-containing functional groups. Given the available surface area and necessary functionalities of biochar sorbents, biochar samples are anticipated to demonstrate a high capacity and relatively high selectivity towards a basket of critical elements. However, selective adsorption of REEs, Al, Mn, and Co necessitate the introduction of practical functionalities with specific affinities toward certain critical elements. Among the functional groups across the literature, amine, hydroxyl, and carboxylate/carboxylic were some of the most utilized for selective REE uptake (Survey et al., 2021). For example, Wang et al. used ammonium citrate to produce carboxyl-amino-modified biochar, which significantly improved the selective adsorption of La. The functionalized biochar exhibited fast adsorption kinetics and a strong adsorption ability for La (III) in the pH range of 3-9. While not applied for biochar functionalization, multiple studies reported a transition of effective liquid-liquid extractants into a more environmentally friendly form (for functionalizing silica sorbents) with the added benefit of better performance. For example, Mohammad et al. (2020) and Nishihama et al. (2018) used commercial REE extractants, Cyanex 272 and PC-88A, to functionalize silica sorbents for selective extraction of REEs in batch and continuous modes. In the case of Al, a similar strategy can be followed to selectively extract the Al3+ using a chitosan-functionalized biosorbent. Chitosan is a biocompatible and biodegradable polymer with specific properties that make it suitable for developing sorbents to remove heavy metals from an aqueous solution. Recently, Özkahraman (2018) showed the high capabilities of chitosan-imprinted sorbents for the selective recovery of Al (>80%) in the presence of competing ions such as Co, Cu, and Zn.

D Mn is one of the significant, and critical elements in AMD streams. Overall, bio-based sorbents have a high potential capability for Mn removal through complexation and ion exchange adsorption mechanisms (based on our present Examples and Lee et al., 2020). To further improve the selectivity of solid-phase extraction of Mn, Khajeh and Sanchooli (2011) utilized vinyl-pyridine imprinted polymer sorbent for the selective extraction of Mn in the presence of other competing ions (e.g., Co and Pb). Also, other studies showed that vinyl-pyridine could strongly coat activated carbon sorbents for metal ion extraction.

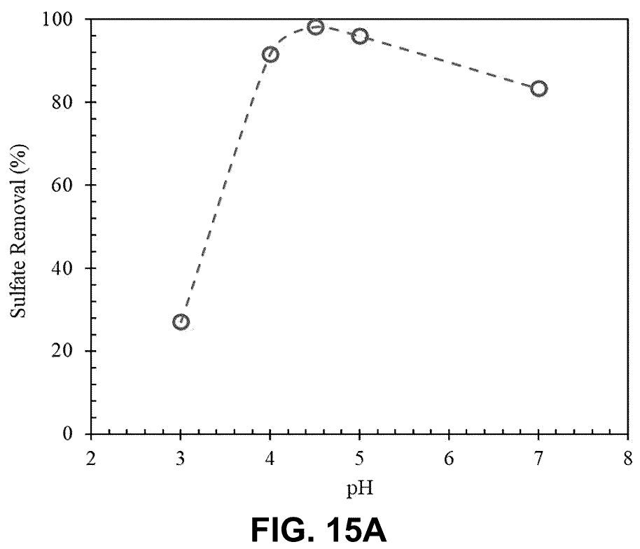

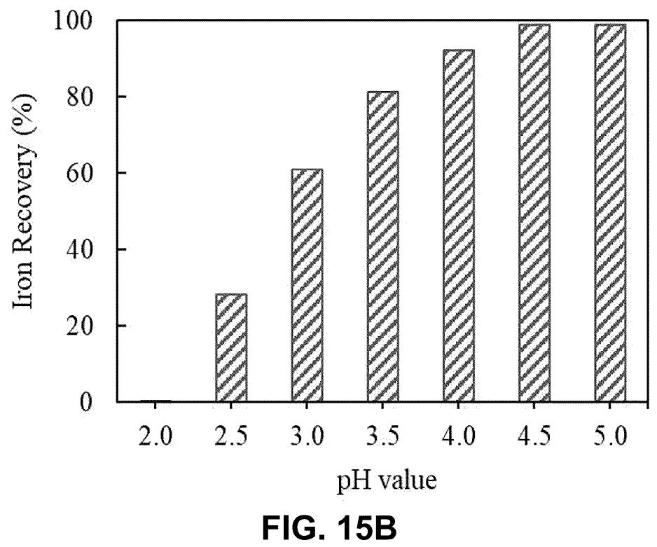

Removal of AMD Impurities (Fe, SO₄). Previous studies showed that anionic species present in AMD, such as sulfate, can influence the binding mechanism of REE species to functionalized sorbents. Due to pyrite dual-oxidation during AMD generation, untreated AMD streams, including those in the Appalachian region, contain a high sulfate concentration (average of 1091 mg/L). Therefore, practical critical element extraction from AMD necessitates sulfate removal at the early stages of the process. Within the context of exploratory testing, t sulfate concentration was successfully reduced in a dilute sample using aluminum chloride. As depicted in FIG. 15A, when treating a solution of 1,800 mg/L sulfates with aluminum chloride, over 98% of sulfate was removed at a pH of around 4.5.

The preliminary analysis of AMD samples also revealed high Fe content. Systematic oxidation and iron precipitation of diluted solutions was conducted at low pH values of below 4.5. These preliminary tests showed that Fe could be removed from AMD at acidic pH (2.5-5) values (FIG. 15B).

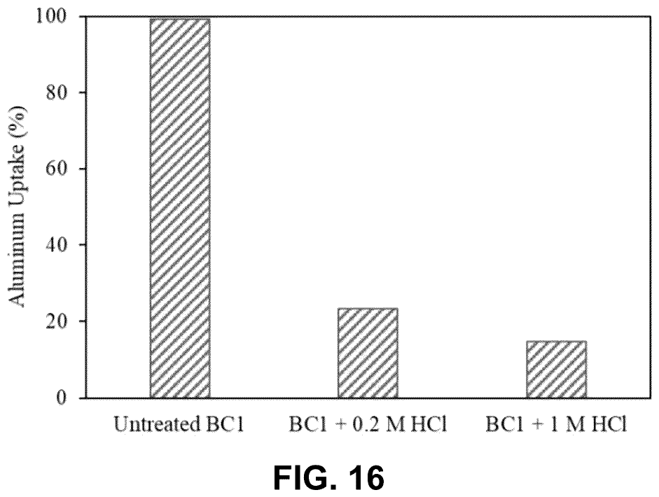

Biochar Regeneration. Regeneration of the biochar adsorbent material can be considered in economic development. Regeneration must produce a small volume of critical element concentrates suitable for metal-recovery process, without damaging the capacity of the adsorbent, making it reusable in several adsorption and desorption cycles. Regeneration should also ensure that the solution is not posing any disposal problem waste in terms of high acidity. Prior work has documented various methods of biochar regeneration including acid/alkaline wash and heat treatment (Dai et al., 2019). An analysis conducted with SW-biochar showed that HCl wash, even at lower concentrations, leads to loss in sorption capacity of the biochar (FIG. 16).

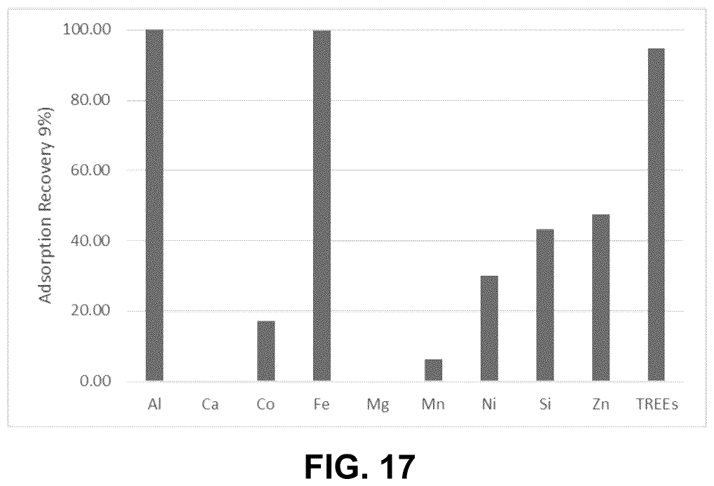

Additional Testing and Results. Real AMD system adsorption tests were conducted under baseline conditions (i.e., 50 ml feedstock with 50 mg biochar at pH 5) to determine the recovery of rare earth and other elements. The biochar utilized in these experiments was derived from Appalachian hardwood, selected for its superior adsorption capabilities compared to biochar produced from softwood and mixture of chicken litter and woodchips. Previous adsorption tests (outlined in the proposal) indicated that Appalachian hardwood biochar outperformed other variants, making it the ideal candidate for this study. The elemental composition of the feedstock used here is given in Table 4. As seen, the concentration of total rare earths (TREEs) is 1.63 ppm while the major contents come from Y, Cₑ, and Nd. On the other hand, the concentration of major impurity elements is 453.76 ppm, with Ca, Mg, and Co having the highest contents. FIG. 17 shows the adsorption test results. High adsorption recoveries were observed for Al (99%), Fe (99%), and REEs (94.6%). Aligned with the preliminary results, no Ca recovery was seen. This phenomenon generated the conclusion of biochar's preferential adsorption of 3+ elements rather than 2+. This selective adsorption behavior may be attributed to the stronger electrostatic interactions between the negatively charged functional groups on the biochar surface and trivalent cations. Additionally, it is believed that the hydrated ionic radius and complexation behavior of trivalent ions facilitate stronger binding to adsorption sites.

TABLE 4
Elemental composition of the feedstock used. Concentrations are given in mg/L.

| Element | Sc | Y | La | Ce | Pr | Nd | Sm | Eu | Gd |
|---|---|---|---|---|---|---|---|---|---|
| Concentration | 0.007 | 0.39 | 0.09 | 0.32 | 0.07 | 0.36 | 0.10 | 0.02 | 0.12 |

| Element | Tb | Dy | Ho | Er | Tm | Yb | Lu | TREE |
|---|---|---|---|---|---|---|---|---|
| Concentration | 0.01 | 0.07 | 0.01 | 0.04 | 0.004 | 0.02 | 0.003 | 1.63 |

| Element | Al | Ca | Fe | Mg | Mn | Si | Co | Ni | Zn |
|---|---|---|---|---|---|---|---|---|---|
| Concentration | 47.95 | 184.53 | 3.57 | 158.89 | 39.76 | 13.94 | 184.53 | 1.20 | 2.88 |

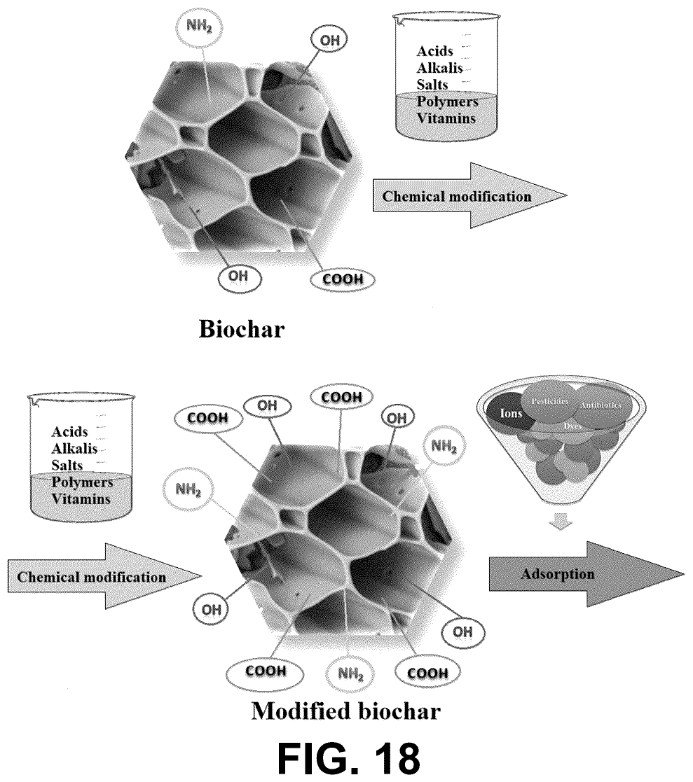

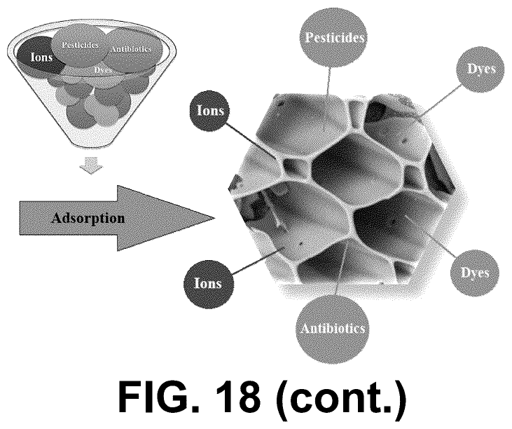

With the purpose of developing a tailored biochar toward REEs for selectivity, modification studies were performed aimed at enhancing the physicochemical properties of biochar. Extensive research has shown that acid treatments can significantly improve biochar's structural and surface characteristics by removing impurities and introducing new functional groups. Such modifications are critical for optimizing adsorption and selective recovery. FIG. 18 highlights the theoretical improvements achieved through these chemical treatments. Other modification approaches alkaline washing, and the application of oxidizing agents, metal oxides, steam, and gas.

The modification studies began with acid/base washing to establish effective methods for enhancing selectivity. Various reagents and concentrations were tested, as summarized in Table 5. Each test involved treating 2 grams of biochar with 50 mL of acid or base solution, followed by shaking for 12 hours. At the end of the mixing period, the solution was filtered and dried (either oven-dried or air-dried to evaluate effects on functional groups). These test conditions were determined based on literature review and previously published papers in similar areas (Pourret and Houben, 2018; Lonappan et al., 2020; Dai et al., 2022). For the preliminary functionalization tests, different particle sizes (500 μm and <75 μm) were also tested to assess size-dependent responses to chemical modifications.

TABLE 5
Surface modification test reagents and their concentrations

| Reagent | Concentration (M) |
|---|---|
| Nitric Acid (HNO₃) | 0.05, 0.1, 0.5, 1, 3 |
| Hydrochloric Acid (HCl) | 0.05, 0.1, 0.5, 1, 3 |
| Sulfuric Acid (H₂SO₄) | 0.05, 0.1, 0.5, 1, 3 |
| Phosphoric Acid (H₃PO₄) | 0.5, 1, 2 |
| Oxalic Acid (C₂H₂O₄) | 0.5, 1 |
| Sodium Hydroxide (NaOH) | 0.5, 1, 2 |
| Water wash | — |

Zeta Potential Analysis. To investigate the performance of functionalization tests, the treated biochars were subjected to several characterization tests. Zeta potential measurements, presented in Table 6, provide insights into the impact of acid and base washing on biochar surface charge. High concentrations of hydrochloric acid and nitric acid resulted in increased negative surface charges, indicating the removal of impurities from the biochar surface, resulting in an increase in surface area. For example, the surface charge of the control sample (raw biochar) significantly changed from −26.5 mV, achieving values as low as −46.6 mV for <75 μm biochar treated with 1M hydrochloric acid. In contrast, sulfuric acid treatments led to less predictable changes. Possible explanations for sulfuric acid's unpredictability include the potential for biochar aggregation or surface clogging due to the formation of sulfate complexes. Between the three acids tested, hydrochloric acid and nitric acid yielded better than sulfuric acid. Therefore, subsequent tests did not include sulfuric acid.

TABLE 6
Zeta potential measurements after reagent treatment.

| Washing | Biochar | Concentration | Zeta |
|---|---|---|---|
| Agent | size (μm) | (M) | Potential (Mv) |
| Control | 500 | | −26.5 |
| Water | | | −29.6 |
| HCl | 500 | 0.05 | −26.1 |
| | | 0.1 | −26.5 |
| | | 0.5 | −36.5 |
| | | 1 | −36 |
| | | 3 | −34.2 |
| | <75 | 1 | −46.6 |
| | | 3 | −43.9 |
| HNO₃ | 500 | 0.05 | −24.9 |
| | | 0.1 | −27.3 |
| | | 0.5 | −34.9 |
| | | 1 | −39.2 |
| | | 3 | −39.1 |
| | <75 | 1 | −39.5 |
| | | 3 | −44.9 |
| H₂SO₄ | 500 | 0.05 | −31.1 |
| | | 0.1 | −29.5 |
| | | 0.5 | −30.1 |
| | | 1 | −24.1 |
| | | 3 | −13.3 |
| | <75 | 1 | −23.5 |
| | | 3 | −21 |

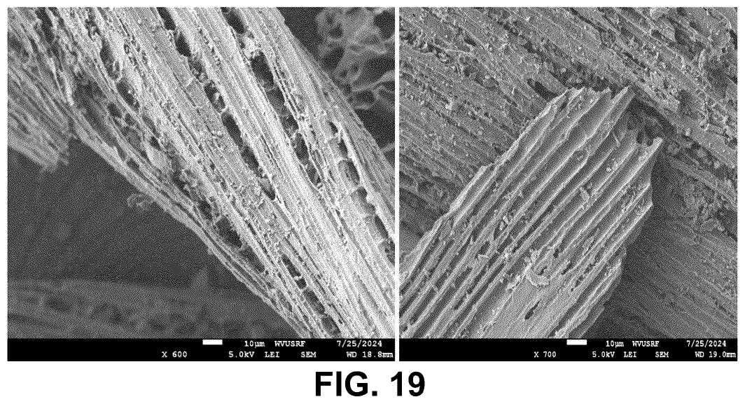

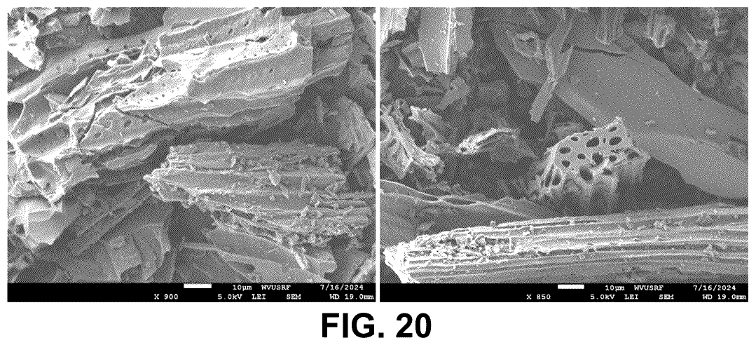

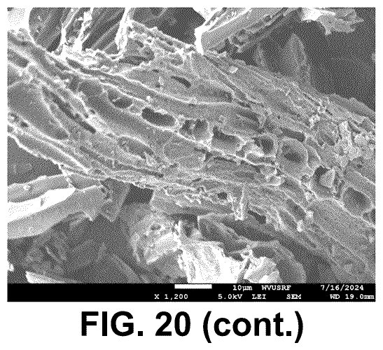

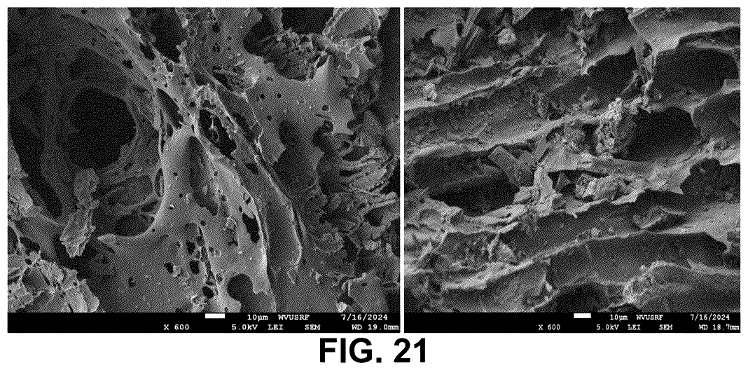

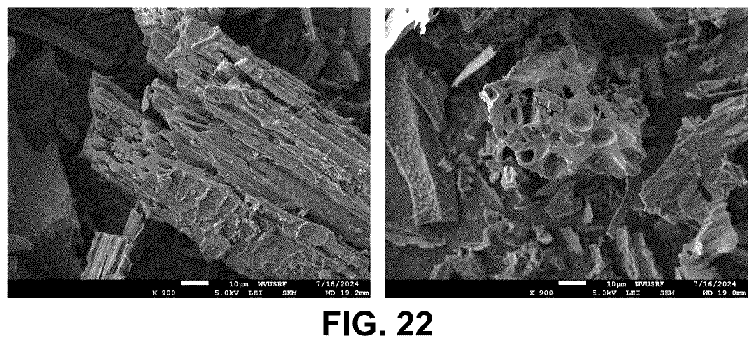

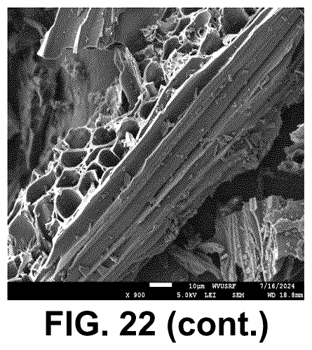

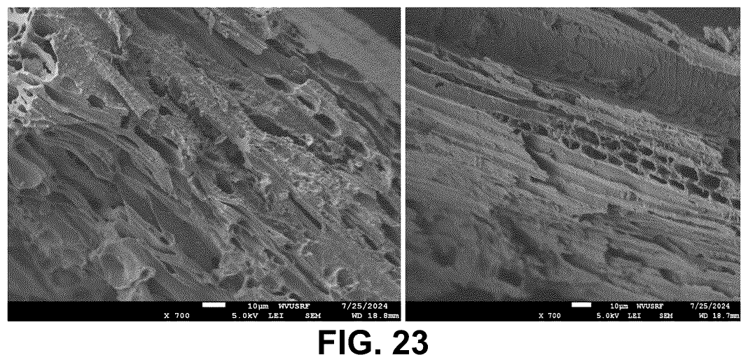

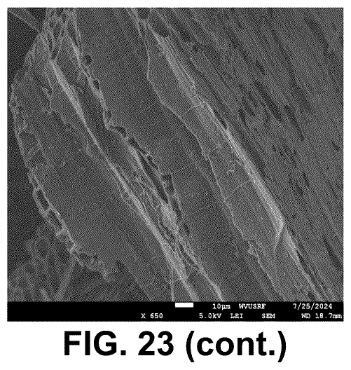

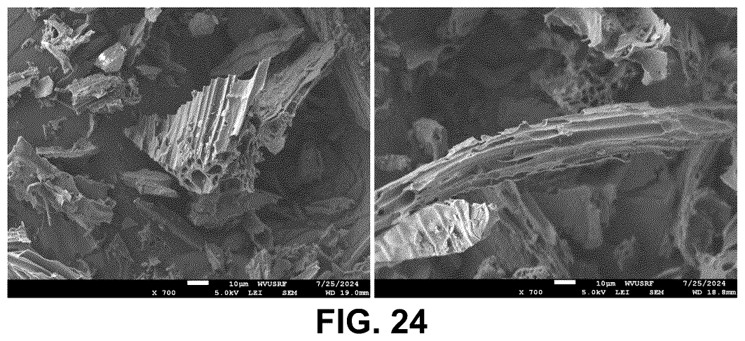

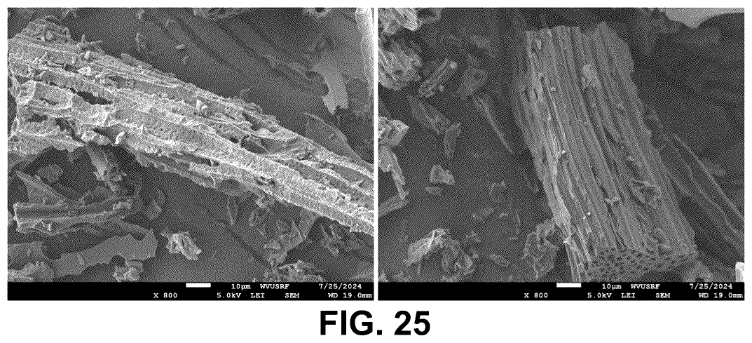

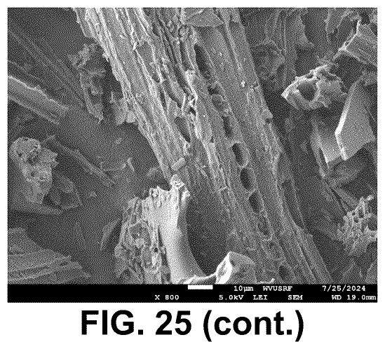

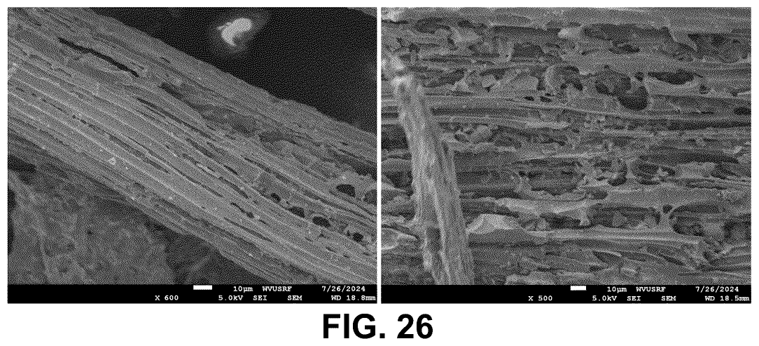

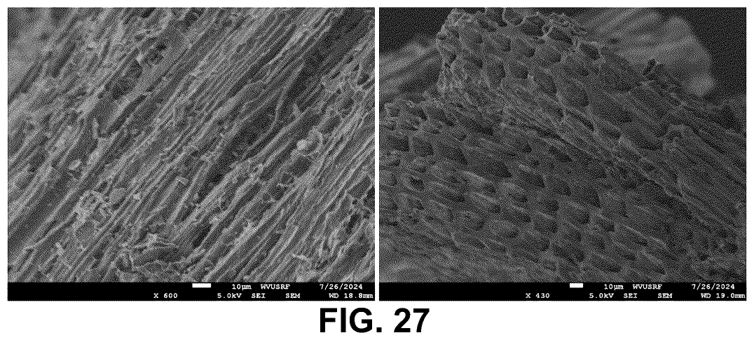

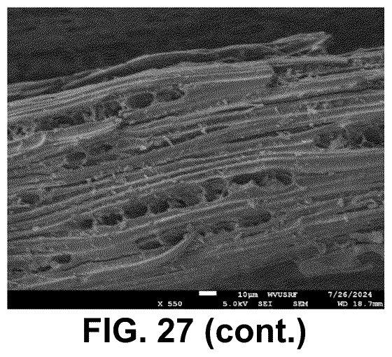

Scanning Electron Microscopy (SEM) Analysis. The effects of high acid concentrations on biochar structures and pore arrangements were further analyzed using Scanning Electron Microscopy (SEM). FIG. 19 illustrates the structural arrangement of untreated biochar, showing well-defined pores and surface features. Following acid treatments, FIGS. 20-27 depict the impact of 1M and 3M concentrations of nitric acid and hydrochloric acid on biochar surfaces, respectively. SEM images may indicate that these treatments enhanced the exposure of adsorption sites without causing observable structural destruction. Specifically, FIG. 22 and FIG. 24 show the improved pore arrangement in <75 μm biochar treated with 1M and 3M nitric acid, respectively. Similarly, FIG. 26 and FIG. 27 highlight the enhanced surface texture of biochar treated with hydrochloric acid. These findings are corroborated by the high negative surface charges observed in zeta potential measurements, suggesting successful impurity removal and improved adsorption potential.

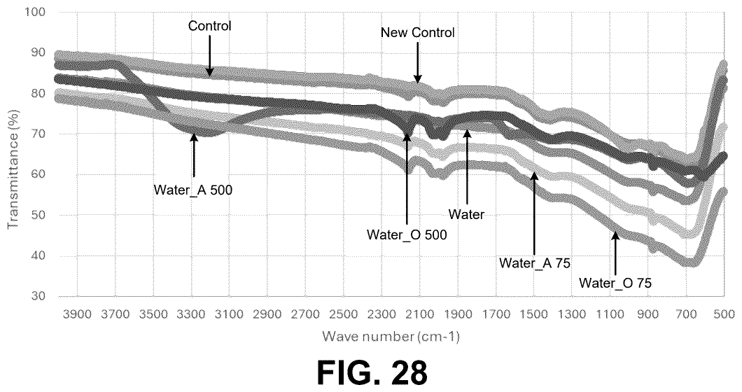

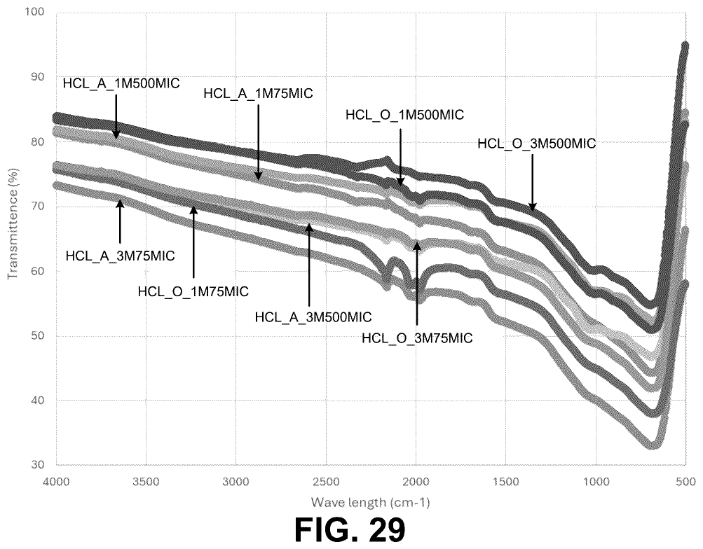

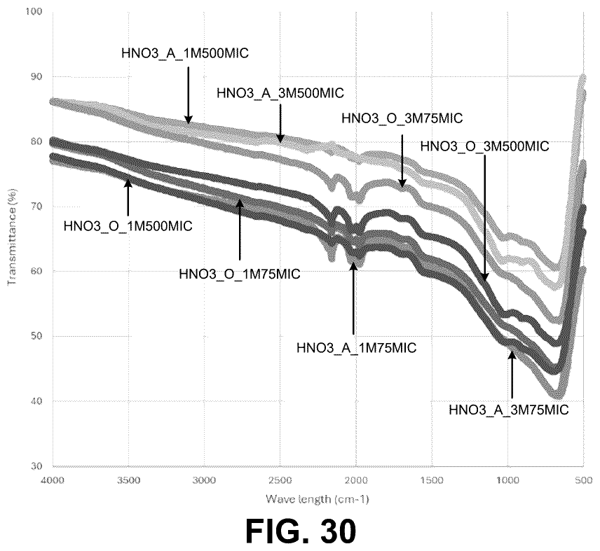

Fourier Transform Infrared (FTIR) Characterization. Following the SEM characterization, functional group analysis was conducted using Fourier Transform Infrared (FTIR) spectroscopy to investigate chemical changes on the biochar surface. Control samples, water-washed samples, and acid-treated samples were analyzed, with results displayed in FIGS. 28-30. The FTIR spectra revealed visible functional groups such as carbon-carbon and carbon-nitrogen triple bonds (alkynes and nitriles) within the range of 1950 to 2250 cm⁻¹. These functional groups were consistently observed across all samples, suggesting that the chemical modifications did not introduce new functional groups but rather enhanced the intensity of existing ones. This increased spike intensity indicates improved surface and pore cleaning as a result of higher acid concentrations. However, some expected functional groups, such as C—O, C═O, and OH, commonly found on pristine biochar, were not prominently observed. Further FTIR studies are planned, utilizing improved equipment with better transmittance capabilities, to gain deeper insights into the surface chemistry of modified biochar.

Pore Size Characterization. Characterization studies continued with BET (Brunauer-Emmett-Teller) and BJH (Barrett-Joyner-Halenda) analyses to quantify surface area and pore volume improvements. Table 7 and Table 8 summarize the results, highlighting the impact of various chemical treatments on biochar properties. Acid washing with high concentrations of hydrochloric and nitric acids generally increased the pore volume but reduced the overall surface area. For instance, nitric acid treatments at 1M and 3M concentrations improved pore volume by 21% and 12%, respectively, but surface area reductions of 53% and 43% were observed. These findings suggest that while high-concentration acid washing enhances pore accessibility and surface charge, it may also compromise the biochar's structural integrity. Moreover, this trade-off between pore volume and surface area may also be explained by the phenomenon of acid-induced pore wall degradation, leading to coalescence of micropores into mesopores which will be further investigated. Interestingly, the adsorption recovery of REEs decreased for acid-treated samples compared to unmodified biochar, underscoring the complex trade-offs between structural modification and adsorption efficiency.

TABLE 7
BJH pore analysis results.

| | Biochar | | Zeta | Surface | | | Pore Volume |
|---|---|---|---|---|---|---|---|
| Washing | particle | Concentration | potential | Area | Pore size | Pore Volume | Increase |
| agent | size (μm) | (M) | (Mv) | (m²/g) | (nm) | (cm³/g) | (%) |
| Control | 500 | Control | −26.5 | 42.102 | 4.9632 | 0.05224 | 0 |
| Water | | Water | −29.6 | 43.239 | 4.9872 | 0.053911 | 3 |
| HCl | 500 | 1 | −36 | 42.479 | 4.4023 | 0.046751 | −11 |
| | | 3 | −34.2 | 39.7 | 4.6295 | 0.045947 | −12 |
| | 75 | 1 | −46.6 | 58.09 | 4.5393 | 0.065922 | 26 |
| | | 3 | −43.9 | 63.726 | 4.3341 | 0.069048 | 32 |
| HNO₃ | 500 | 0.5 | −34.9 | 60.748 | 4.1578 | 0.063145 | 21 |
| | | 1 | −39.2 | 60.209 | 4.1249 | 0.062089 | 19 |
| | | 3 | −39.1 | 50.695 | 4.6306 | 0.058688 | 12 |
| | 75 | 1 | −39.5 | 56.467 | 4.1841 | 0.059066 | 13 |
| | | 3 | −44.9 | 63.742 | 4.238 | 0.067535 | 29 |

TABLE 8
BET pore analysis results.

| | Biochar | | Zeta | Surface | Surface Area | Adsorption |
|---|---|---|---|---|---|---|
| Washing | particle | Concentration | potential | Area | Reduction | Recovery |
| agent | size (μm) | (M) | (Mv) | (m2/g) | (%) | (%) |
| Control | 500 | Control | −26.5 | 1002.85 | 0 | 96.74 |
| Water | | Water | −29.6 | 985.46 | 2 | 96.60 |
| HCl | 500 | 1 | −36 | 387.43 | 61 | 52.39 |
| | | 3 | −34.2 | 313.10 | 69 | 52.07 |
| | 75 | 1 | −46.6 | 386.31 | 61 | 61.07 |
| | | 3 | −43.9 | 308.82 | 69 | 53.22 |
| HNO₃ | 500 | 0.5 | −34.9 | 363.55 | 64 | 44.31 |
| | | 1 | −39.2 | 466.89 | 53 | 57.61 |
| | | 3 | −39.1 | 573.30 | 43 | 55.11 |
| | 75 | 1 | −39.5 | 488.30 | 51 | 60.14 |
| | | 3 | −44.9 | 584.68 | 42 | 53.22 |

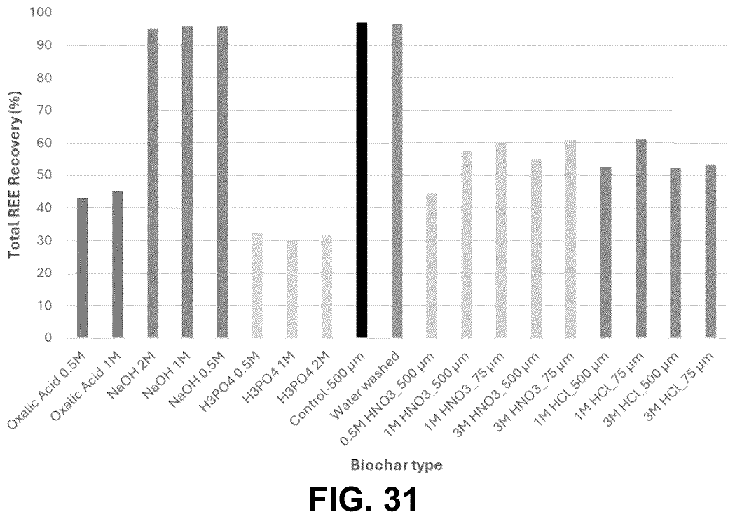

Biochar Absorption Performance. In Table 7 and Table 8 above, BHJ and BET analysis revealed surface area reduction on modified biochar. This is consistent with the adsorption test as FIG. 31 below shows low recoveries of REE by acid washed biochar as compared to the unmodified one. However, washing with sodium hydroxide solution has yielded comparable recovery results with those of original biochar and water washed biochar. FIG. 31 shows recoveries of about 95% of REE though what needs to be established is improvement in the surface area and there was additional hydroxyl functional groups, or it is just the alkaline environment that has led to that recovery.

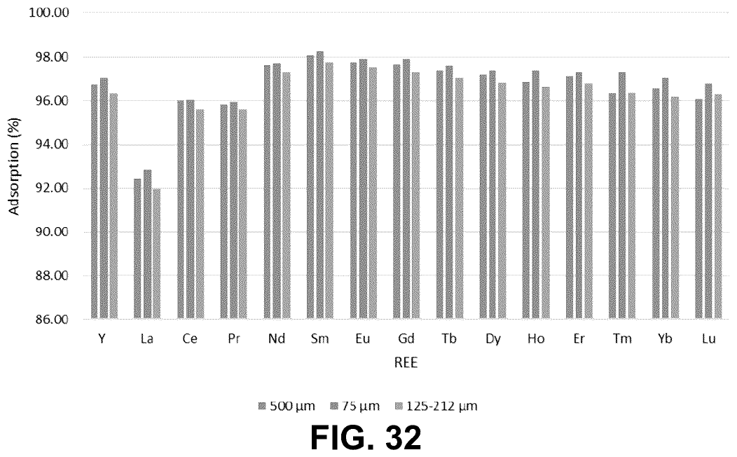

Following the characterization tests, to evaluate the impact of particle size on adsorption efficiency, additional adsorption tests were performed. For this purpose, biochar samples were crushed, ground, and sieved into specific size ranges: 125-212 μm and <75 μm. These sizes were compared against the baseline size of 500 μm, which had been used in preliminary data generation. The raw biochar was initially approximately 1 mm in size before processing. The results, presented in FIG. 32, revealed only a slight improvement in recovery for the finest particles (<75 μm), which demonstrated approximately a 1% increase compared to the 500 μm biochar. This marginal gain does not justify the additional time and energy costs associated with further size reduction, suggesting that 500 μm remains the most suitable and cost-effective particle size for adsorption processes.

Table 9 notes different functionalization strategies for a range of biochars.

TABLE 9
Biochar functionalization strategies.

| | Chemicals | Testing | | | | | |
|---|---|---|---|---|---|---|---|
| | for | Mixture | | | | | |
| Type of | Functional- | (single ion/ | Target | Performance | | Character- | References |
| Sorbent | ization | mixture) | Minerals | Matrix | Reversibility | ization | (DOI) |
| Sequential | H-adjusted | Mixture | Mn²⁺, | Mn retained | Recovery | ICP-MS, | 10.1016/ |
| Precipitation | precipitation | (Mn²⁺, | Co²⁺, | at 50%, | selective; Mn | XRD, | j.resconrec. |
| | & sulfides | Co²⁺, | Ni²⁺, Zn²⁺ | Co/Ni/Zn | retained at | SEM-EDS | 2022.106214 |
| | | Ni²⁺, Zn²⁺) | | selectively | pH 5.00 | | |
| | | | | precipitated | | | |
| | | | | at pH 4.00, | | | |
| | | | | Co/Ni >94% | | | |
| | | | | purity | | | |
| Biochar | NA | Single ion | Sm³⁺ | Adsorption | Irreversible; | ICP-MS, | 10.1016/ |
| (Castor Meal- | | (Sm³⁺) | | capacity: 7.2 | desorption | FTIR, | j.chemosphere. |
| CM) | | | | mg/g; Kd: | <5.5% | ICP-OES | 2021.132138 |
| | | | | 1750-48800 | | | |
| | | | | L/kg; Sm | | | |
| | | | | removal: | | | |
| | | | | >97% | | | |
| Biochar | NA | Single ion | Sm³⁺ | Adsorption | Irreversible; | ICP-MS, | |
| (Eucalyptus- | | (Sm³⁺) | | capacity: 6.8 | desorption | FTIR, | |
| CE) | | | | mg/g; Kd: | <5.5% | ICP-OES | |
| | | | | 1350-14900 | | | |
| | | | | L/kg; Sm | | | |
| | | | | removal: | | | |
| | | | | >97% | | | |
| Biochar | NA | Single ion | Sm³⁺ | Adsorption | Irreversible; | ICP-MS, | |
| (Coconut- | | (Sm³⁺) | | capacity: 8.5 | desorption | FTIR, | |
| PC) | | | | mg/g; Kd: | <5.5% | ICP-OES | |
| | | | | 859-75300 | | | |
| | | | | L/kg; Sm | | | |
| | | | | removal: | | | |
| | | | | >97% | | | |
| Biochar | NA | Single ion | Sm³⁺ | Adsorption | Irreversible; | ICP-MS, | |
| (Sugarcane- | | (Sm³⁺) | | capacity: 1.2 | desorption | FTIR, | |
| SB) | | | | mg/g; Lower | <5.5% | ICP-OES | |
| | | | | sorption | | | |
| | | | | efficiency | | | |
| Coal Fines | NA | Single ion | Sm³⁺ | Adsorption | Irreversible; | ICP-MS, | |
| (CF) | | (Sm³⁺) | | capacity: 40 | desorption | FTIR, | |
| | | | | mg/g; Best | <5.5% | ICP-OES | |
| | | | | sorbent | | | |
| | | | | among tested | | | |
| | | | | materials | | | |
| Activated | NA | Single ion | Sm³⁺ | Adsorption | Irreversible; | ICP-MS, | |
| Charcoal | | (Sm³⁺) | | capacity: 36 | desorption | FTIR, | |
| (GAC) | | | | mg/g; | <5.5% | ICP-OES | |
| | | | | Highest SSA | | | |
| Activated | NA | Single ion | Sm³⁺ | Adsorption | Irreversible; | ICP-MS, | |
| Charcoal | | (Sm³⁺) | | capacity: 12 | desorption | FTIR, | |
| (NGAC) | | | | mg/g; | <5.5% | ICP-OES | |
| | | | | Moderate | | | |
| | | | | sorption | | | |
| | | | | efficiency | | | |
| (NH₄)₂SO₄- | Ammonium | | U, V, Ga | Leaching | Partial | XRD, | 10.1016/ |
| Treated Coal | sulfate | | | efficiency | reversibility | ICPMS, | j.jhazmat.2020. |
| Ash | | | | increased by | with acid | SEM | 122113 |
| | | | | 1.9× (U), | leaching | | |
| | | | | 1.3× (V), | | | |
| | | | | 5.0× (Ga) | | | |
| strong acid | Sulfonic Acid | | La, Pr, | 85% REE, | Reusable, | FTIR, | 10.1016/ |
| cation resin | (—SO₃H) | | Nd, Sm, | and 83% | selective | ICP-OES, | j.jwpe.2021. |
| (LEWATIT ® | | | Eu, Gd, | recovery | REE elution | XRD | 102052 |
| MDS 200H) | | | Dy, and | efficiency | with | | |
| | | | Er | | NH₄EDTA | | |
| Ion-Imprinted | Oxygen- | Sc(III), | Sc(III), | High | Stable & | XPS, TEM | 10.3390/ |
| Polymer (IIP- | phosphorus | Y(III) | Y(III) | selectivity, | reusable | | molecules29122824 |
| BT/CoFe2O4 | functional | | | magnetic | | | |
| @SiO2 | group | | | separation | | | |
| Chitosan- | Thermo- | Y(III) | Y(III) | Adsorption | Reversible | FTIR, SEM | |
| Based | responsive | | | capacity: 160 | | | |
| Hydrogel | polymer | | | mg/g | | | |
| MWCNT- | Multi-walled | Gd(III), | Gd(III), | Adsorption | High | SEM, BET | |
| PDA-CS-GO | CNT, | La(III) | La(III) | capacity: | selectivity & | | |
| Aerogel | Polydopamine, | | | 150.86 mg/g, | reproducibility | | |
| | Graphene | | | pH 7 | | | |
| | oxide | | | | | | |
| Graphene | N,N-Bis(2- | La(III), | La(III), | High | Effective in | ICP-OES, | |
| Oxide-Based | hydroxyethyl) | Nd(III), | Nd(III), | selectivity | multiple | FTIR, | |
| Adsorbent | glycine | Er(III), | Er(III), | | cycles | SEM, XRD | |
| | | Yb(III) | Yb(III) | | | | |
| Poly(vinyl | Hydrophilic | Heavy | Heavy | Separation | Enhanced | SEM, TGA | |
| alcohol)- | additive | REEs | REEs | factor: 3.78 | regeneration | | |
| ethylene | | (Dy(III), | (Dy(III), | | | | |
| copolymer | | Tb(III)) | Tb(III)) | | | | |
| (EVOH) | | | | | | | |
| Membrane | | | | | | | |
| Phosphorylated | Vinyl- | La(III), | La(III), | 62.8 mg/g | High | FTIR, XRD | |
| Polymer | phosphonic | Ce(III) | Ce(III) | (La(III)); | chemical | | |
| | acid | | | Stable in | stability | | |
| | | | | acidic media | | | |
| Activated | Glycine, | Gd(III), | Gd(III), | Adsorption | Reusable | ICP-OES, | |
| Carbon | Phosphate, | Ce(III), | Ce(III), | efficiency: | | FTIR, | |
| (NOPAC- | CNTs | La(III), | La(III), | 99% at pH 7 | | SEM | |
| GLY-X) | | Eu(III) | Eu(III) | | | | |
| MOF-Based | PMIDA- | Lu(III), | Lu(III), | 63.4 mg/g | Stable under | ICP-MS, | |
| Adsorbent | modified Cr- | Sc(III), | Sc(III), | (Lu(III)); | acidic | XRD | |
| | MIL-NH2 | Y(III) | Y(III) | Stable under | conditions | | |
| | | | | acidic | | | |
| | | | | conditions | | | |
| Powdered | ZnCl₂ | | La(III), | Adsorption | Reusable up | FTIR, SEM, | 10.1016/ |
| Activated | impregnation | | Ce(III) | capacity: | to 4 cycles | BET, XRD, | j.cej.2023. |
| Carbon (SP- | | | | 127.2 mg/g | | Zeta | 144484 |
| AC) | | | | (La), 107.7 | | Potential | |
| | | | | mg/g (Ce) | | | |
| Layered | (Me₂NH₂)₂ | Single ion | Eu³⁺ | Adsorption | Reversible | EA, Raman, | 10.1016/ |
| Sulfides | (Ga₂Sb₂S7) · | (Eu³⁺) | | capacity: | with 0.2 M | XPS, | j.cej.2020. |
| (FJSM-GAS- | H₂O | | | 127.7 mg/g; | KCl solution, | EXAFS, | 1276 |
| 1) | | | | Equilibration | maintaining | ICP-MS, | |
| | | | | time: <2 min; | adsorption | ICP-OES | |
| | | | | Distribution | efficiency | | |
| | | | | coefficient | after 4 cycles | | |
| | | | | (Kd) = | | | |
| | | | | 6.39 × 10⁵ | | | |
| | | | | mL/g | | | |
| Layered | (Et₂NH₂)₂ | Single ion | Eu³⁺ | Adsorption | Reversible | EA, Raman, | 13 |
| Sulfides | (Ga₂Sb₂S₇) · | (Eu³⁺) | | capacity: | with 0.2 M | XPS, | |
| (FJSM-GAS- | H₂O | | | 115.8 mg/g; | KCl solution, | EXAFS, | |
| 2) | | | | Equilibration | maintaining | ICP-MS, | |
| | | | | time: <2 min; | adsorption | ICP-OES | |
| | | | | Distribution | efficiency | | |
| | | | | coefficient | after 4 cycles | | |
| | | | | (Kd) = | | | |
| | | | | 6.00 × 10⁵ | | | |
| | | | | mL/g | | | |
| Glycine- | Glycine | Gd(III), | Gd(III) | Adsorption | Retains 88% | BET, | 10.1021/ |
| Functionalized | Modification | La(III), | | Capacity: | efficiency | FTIR, | acsaenm. |
| Activated | | Ce(III) | | 48.5 mg/g, | after five | XPS, | 4c00510 |
| Carbon | | | | 99% removal | cycles | EA | |
| (NOPAC- | | | | at pH 7 | | | |
| GLY-X) | | | | | | | |
| Electrospun | Lanmodulin- | La(III), | Lanthanides | High | Stable over | FTIR, | 10.1021/ |
| Membranes | Derived | Nd(III), | (REEs) | Selectivity | multiple | SEM, | acsami. |
| with | Peptides | Sm(III), | | for REEs | adsorption | XPS | 3c17565 |
| Lanmodulin- | | Eu(III), | | | cycles | | |
| Derived | | Gd(III), | | | | | |
| Peptides | | Ho(III), | | | | | |
| | | Er(III), Ca | | | | | |
| Surface- | Peptide | La(III), | Rare | Enhanced | Reusable | XPS, | 10.1021/ |
| Bound | Functional- | Pr(III), | Earth | Selectivity | with | FTIR, | acsami. |
| Affinity | ization | Nd(III), | Elements | and Binding | consistent | SPR | 3c17565 |
| Peptide (EF- | | Sm(III), | (REEs) | Efficiency | performance | | |
| Hand Loop I | | Eu(III), | | | | | |
| of | | Gd(III), | | | | | |
| Lanmodulin) | | Dy(III), | | | | | |
| | | Er(III) | | | | | |
| Anion | No additional | Cu(II), | Cu(II), | Near 100% | Stable across | XPS, | |
| Exchange | functionalizati | Pb(II), | Pb(II), | Cu and Pb | multiple | Electro- | |
| Membrane | on, relies on | Zn(II), | Zn(II), | recovery, Zn | cycles | chemical | |
| (AEMs) | intrinsic ion | Mo(VI) | Mo(VI) | and Mo | | Methods | |
| | exchange | | | efficiency | | | |
| | properties | | | varied | | | |
| Lanmodulin | Protein | La(III), | La(III), | LanM shows | High | Molecular | |
| (LanM) and | Engineering | Nd(III), | Nd(III), | high REE | structural | Dynamics | |
| its Variants | (EF-hand | Sm(III), | Sm(III), | selectivity, | stability with | Simulations, | |
| (4P2A, | mutations: | Gd(III), | Gd(III), | EF-hand | altered | Binding | |
| 4D9X) | 4P2A, 4D9X) | Tb(III), | Tb(III), | mutations | binding | Energy | |
| | | Y(III) | Y(III) | alter affinity | specificity | Calculations, | |
| | | | | and | | Circular | |
| | | | | selectivity | | Dichroism | |
| | | | | | | Spectroscopy | |

Conclusion. In summary, disclosed herein are valuable insights into the role of particle size, surface chemistry, and chemical modification in optimizing biochar for AMD treatment. The findings highlight the importance of balancing performance gains with operational efficiency, as seen in the preference for 500 μm biochar. Additionally, high concentrations of hydrochloric and nitric acids have proven effective in enhancing biochar properties, as evidenced by zeta potential, SEM analyses, and FTIR results.

### G. References

References are cited herein throughout using the format of author(s) name and year published enclosed by parentheses corresponding to one or more of the following references. For example, citation of references numbers 1 and 2 immediately herein below would be indicated in the disclosure as (Alsawy et al., 2022; Chen et al., 2015).
Alsawy, T., Rashad, E., El-Qelish, M., & Mohammed, R. H. (2022). A comprehensive review on the chemical regeneration of biochar adsorbent for sustainable wastewater treatment. Npj Clea Water, 5 (1), 29. doi: 10.1038/s41545-022-00172-3.
Chen, W., Chen, M., & Zhou, X. (2015). Characterization of biochar obtained by co-pyrolysis of waste newspaper with high-density polyethylene, BioRes. 10 (4), 8253-8267.
Dai, X., Nhung, N. T. H., Hamza, M. F., Guo, Y., Chen, L. He, C., et al. (2022). Selective Adsorption and Recovery of Scandium from Red Mud Leachate Using Phosphoric Acid Pre-treated Pitaya Peel Biochar. Separation and Purification Technology. 292, 121043.
Ding, Y., Liu, Y., Liu, S., Li, Z., Tan, X., Huang, X., Zeng, G., Zhou, Y., Zheng, B., & Cai, X. (2016). Competitive removal of Cd (ii) and Pb (ii) by bio-chars produced from water hyacinths: Performance and mechanism. RSC Advances, 6 (7), 5223-5232. doi: 10.1039/C5RA26248H.
He H, Gan Q, Feng C. Synthesis and characterization of a surface imprinting silica gel polymer functionalized with phosphonic acid groups for selective adsorption of Fe (III) from aqueous solution. J Appl Polym Sci. 2017;134 (36): 1-10.
Hu Y, Florek J, Larivière D, Fontaine FG, Kleitz F. Recent advances in the separation of rare earth elements using mesoporous hybrid materials. Chem Rec. 2018; 18 (7-8): 1261-76.
Khajeh M, Sanchooli E. Synthesis of ion-Selective imprinted polymer for manganese removal from environmental water. Polym Bull. 2011; 67 (3): 413-25.
Kołodyńska, D., Bąk, J., Majdańska, M., & Fila, D. (2018). Sorption of lanthanide ions on biochar com-posites. Journal of Rare Earths, 36 (11), 1212-1220. doi: 10.1016/j.jre.2018.03.027.
Lee JE, Park YK. Applications of modified biochar-based materials for the removal of environmental pollutants: A mini review. Sustain. 2020; 12 (15).
Li, X., Song, Y., Bian, Y., Wang, F., Gu, C., Yang, X., & Jiang, X. (2019). Effects of root exudates on the sorp-tion of polycyclic aromatic hydrocarbons onto biochar. Environmental Pollutants and Bioavailability, 31 (1), 156-165. doi: 10.1080/26395940.2019.1593054.
Lonappan, L., Liu, Y., Rouissi, T., Barr, S. K., Surampalli, R. Y. (2020). Development of Biochar-based Green Functional Materials Using Organic Acids for Environmental Applications. Journal of Cleaner Production. 244, 188141.
Lu Z, Zhang H, Shahab A, Zhang K, Zeng H, Bacha AUR, et al. Comparative study on characterization and adsorption properties of phosphoric acid activated biochar and nitrogen-containing modified biochar employing Eucalyptus as a precursor. J Clean Prod. 2021; 303.
Mohammedi H, Miloudi H, Boos A, Bertagnolli C. Lanthanide recovery by silica-Cyanex 272 material immobilized in alginate matrix. Environ Sci Pollut Res. 2020; 27 (21): 26943-53.
Nishihama S, Harano T, Yoshizuka K. (2018). Silica-based solvent impregnated adsorbents for separation of rare earth metals. Sep Sci Technol. 3;53 (7): 1027-33. DOI: 10.1080/01496395.2017.1310895
Özkahraman B. (2018). Synthesis of lon-Imprinted Bioadsorbents Based on Chitosan and its Usage in Al (III) Removal. J Polym Environ. 26 (3): 1113-20.
Pandey, R., Ghazi Ansari, N., Lakhan Prasad, R., & Chandra Murthy, R. (2014). Pb (II) Removal from Aqueous Solution by Cucumissativus (Cucumber) Peel: Kinetic, Equilibrium &; Thermodynamic Study. American Journal of Environmental Protection, 2 (3), 51-58. doi: 10.12691/env-2-3-1.
Pourret, O. and Houben, D. (2018). Characterization Of Metal Binding Sites Onto Biochar Using Rare Earth Elements As A Fingerprint. Heliyon, 4. doi: 10.1016/j.heliyon.2018.e00543
Ramesh, K., Reddy, K. S., Rashmi, I., & Biswas, A. K. (2014). Porosity Distribution, Surface Area, and Morphology of Synthetic Potassium Zeolites: A SEM and N₂ Adsorption Study. Communications in Soil Science and Plant t Analysis, 45 (16), 2171-2181. doi: 10.1080/00103624.2014.929699.
Saha, P., Chowdhury, S., Gupta, S., & Kumar, I. (2010). Insight into adsorption equilibrium, kinetics and thermodynamics of Malachite Green onto clayey soil of Indian origin. Chemical Engineering Journal, 165 (3), 874-882. doi: 10.1016/j.cej.2010.10.048.
Survey L, (2021). Results E. Datamining Analysis of Rare Earth Element Recovery Research Trends-A Path Forward with Functionalized Silica Sorbents.
Tan, Z., Yuan, S., Hong, M., Zhang, L., & Huang, Q. (2020). Mechanism of negative surface charge forma-tion on biochar and its effect on the fixation of soil C_{d}. Journal of Hazardous Materials, 384, 121370. doi: 10.1016/j.jhazmat.2019.121370.
Thommes, M., Kaneko, K., Neimark, A. V., Olivier, J. P., Rodriguez-Reinoso, F., Rouquerol, J., & Sing, K. S. W. (2015). Physisorption of gases, with special reference to the evaluation of surface area and pore size distri-bution (IUPAC Technical Report). Pure and Applied Chemistry, 87 (9-10), 1051-1069.
Tomczyk, A., Kondracki, B., Szewczuk-Karpisz, K. (2023). Chemical Modification of Biochars As A Method to Improve Its Surface Properties and Efficiency in Removing Xenobiotics from Aqueous Media. Chemosphere. Volume 312, Part 1, 137238.
Vass CR, Noble A, Ziemkiewicz PF. The Occurrence and Concentration of Rare Earth Elements in Acid Mine Drainage and Treatment By-products: Part 1-Initial Survey of the Northern Appalachian Coal Basin. Mining, Metall Explor. Doi: 10.1007/s42461-019-0097-z
Wang, H., Xu, Z., Kohandehghan, A., Li, Z., Cui, K., Tan, X., Stephenson, T. J., King′ondu, C. K., Holt, C. M. B., Olsen, B. C., Tak, J. K., Harfield, D., Anyia, A. O., & Mitlin, D. (2013). Interconnected Carbon Nanosheets Derived from Hemp for Ultrafast Supercapacitors with High Energy. ACS Nano, 7 (6), 5131-5141. doi: 10.1021/nn400731 g.
Wang, Z., Li, J., Zhang, G., Zhi, Y., Yang, D., Lai, X., & Ren, T. (2020). Characterization of Acid-Aged Biochar and Its Ammonium Adsorption in an Aqueous Solution. Materials, 13 (10), 2270. doi: 10.3390/ma13102270.
Zhang, G., Zhang, Q., Sun, K., Liu, X., Zheng, W., & Zhao, Y. (2011). Sorption of simazine to corn straw biochars prepared at different pyrolytic temperatures. Environmental Pollution, 159 (10), 2594-2601. doi: 10.1016/j.envpol.2011.06.012.
Zhao, Q., Wang, Y., Xu, Z., & Yu, Z. (2021). The potential use of straw-derived biochar as the adsorbent for La (III) and Nd (III) removal in aqueous solutions. Environmental Science and Pollution Research, 28 (34), 47024-47034. doi: 10.1007/s11356-021-13988-2.f

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

At least the following is claimed:

1. A method for recovering critical minerals (CMs) from a solution, the method comprising:
(a) providing a CM solution comprising at least one critical mineral and water;
(b) contacting the CM solution with an acid or a base in an amount sufficient enough to adjust the pH to a value of about 2 to about 7;
(c) contacting the CM solution with a first modified biochar, forming a first saturated biochar; and
(d) desorbing the first saturated biochar, thereby forming a first CM precipitate, a first stripped biochar, and a first aqueous phase.

2. The method of claim 1, wherein the first CM precipitate comprises aluminum, manganese, cobalt, magnesium, lithium, a rare earth element, or a combination thereof.

3. The method of claim 1, wherein the pH of the CM solution is adjusted to a value of about 4 to about 6.

4. The method of claim 1, wherein the CM solution is contacted with an acid selected from an organic acid, an inorganic acid, and any combination thereof.

5. The method of claim 1, wherein the CM solution is contacted with a base selected from an organic base, an inorganic base, and any combination thereof.

6. The method of claim 1, wherein the CM solution has been pretreated to reduce the presence of at least one impurity, wherein the at least one impurity is selected from iron and sulfate.

7. The method of claim 1, wherein the CM solution has a sulfate concentration of 0.01% to about 2%.

8. The method of claim 1, wherein the CM solution has an iron concentration of 0.01% to about 2%.

9. The method of claim 1, wherein the modified biochar has a carbon content of about 60 wt % to about 96 wt %.

10. The method of claim 1, wherein the modified biochar is functionalized with at least one functional group selected from a carboxyl group, a hydroxy group, a peptide, and an amine.

11. The method of claim 1, wherein the modified biochar has a surface area of about 60 m²/g to about 1000 m²/g.

12. The method of claim 1, wherein the modified biochar has an adsorption capacity of about 1 mg/g to about 200 mg/g.

13. The method of claim 1, wherein the modified biochar has a zeta potential of about −5 Mv to about −60 Mv.

14. The method of claim 1, wherein desorbing the saturated biochar is performed via thermal regeneration, chemical regeneration, microwave-assisted regeneration, or a combination thereof.

15. The method of claim 1, wherein the CM solution is a first CM solution; and the method is iterative wherein an aqueous phase formed by the desorbing step is provided as an additional CM solution for recovering CMs from the additional CM solution.

16. The method of claim 1, further comprising:
(a) separating the first aqueous phase from the first stripped biochar and the first CM precipitate;
(b) contacting the first aqueous phase with a second modified biochar, thereby forming a second saturated biochar; and
(c) desorbing the second saturated biochar, thereby forming a second CM precipitate, a second stripped biochar, and a second aqueous phase.

17. The method of claim 16, wherein the second CM precipitate comprises manganese, cobalt, a rare earth element, or a combination thereof.

18. The method of claim 16, wherein the second aqueous phase comprises cobalt, a rare earth element, or a combination thereof.

19. The method of claim 16, further comprising:
(a) separating the second aqueous phase from the second stripped biochar and the second CM precipitate;
(b) contacting the second aqueous phase with a third modified biochar, thereby forming a third saturated biochar; and
(c) desorbing the third saturated biochar, thereby forming a third CM precipitate, a third stripped biochar, and a third aqueous phase.

20. The method of claim 19, wherein the third CM precipitate comprises cobalt, a rare earth element, or a combination thereof.
